(19) United States
(12) Patent Application Publication
(10) Pub. No.: US 2024/0259079 A1
(43) Pub. Date: Aug. 1, 2024

(54) QUASI CO-LOCATION INFORMATION FOR 3D BEAMFORMING IN HOLOGRAPHIC MULTIPLE-INPUT MULTIPLE-OUTPUT SYSTEMS

(71) Applicant: QUALCOMM INCORPORATED, San Diego, CA (US)

(72) Inventors: Min Huang, Beijing (CN); Wei Xi, Beijing (CN); Chao Wei, Beijing (CN); Yu Zhang, San Diego, CA (US); Chenxi Hao, Beijing (CN); Qiaoyu Li, Beijing (CN); Hao Xu, Beijing (CN); Kangqi Liu, San Diego, CA (US); Jing Dai, Beijing (CN); Danlu Zhang, San Diego, CA (US); Sony Akkarakaran, Poway, CA (US)

(21) Appl. No.: 18/560,642

(22) PCT Filed: Jul. 29, 2021
(86) PCT No.: PCT/CN2021/109141

§ 371 Date: Nov. 13, 2023

(51) Int. Cl. H04B 7/06; H04B 7/0413

(52) U.S. Cl. CPC H04B 7/06968; H04B 7/0413

(57) ABSTRACT

Methods, systems, and devices for wireless communications are described. In a wireless communications system. a user equipment (UE) may receive. from a base station, control signaling indicating a quasi co-location (QCL) configuration associated with multiple-input multiple output (MIMO) communications within a distance threshold from the base station. In some cases, the UE may receive. from the base station, an indication of a downlink transmission associated with the QCL configuration within the distance threshold. The UE may select a beam to receive the downlink transmission within the distance threshold based on the QCL configuration. In some cases. the UE may receive multiple repetitions of the downlink transmission using corresponding antenna combining weight configurations, and the UE may determine a beam weight configuration for the beam to receive the downlink transmission based on receiving the multiple repetitions of the downlink transmission.

### CROSS REFERENCE

The present Application is a 371 national stage filing of International PCT Application No. PCT/CN2021/109141 by Huang et al. entitled “QUASI CO-LOCATION INFORMATION FOR 3D BEAMFORMING IN HOLOGRAPHIC MULTIPLE-INPUT MULTIPLE-OUTPUT SYSTEMS,” filed Jul. 29, 2021, which is assigned to the assignee hereof, and which is expressly incorporated by reference in its entirety herein.

### FIELD OF TECHNOLOGY

The following relates to wireless communications, including quasi co-location (QCL) information for three dimensional (3D) beamforming in holographic multiple-input multiple-output (MIMO) systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, devices may be configured to communicate using beamforming techniques. However, beamforming techniques for devices in the near field may be deficient.

### SUMMARY

The described techniques relate to improved methods, systems, devices, and apparatuses that support quasi co-location (QCL) information for three dimensional (3D) beamforming in holographic multiple-input multiple-output (MIMO) systems. Generally, the described techniques provide for a user equipment (UE) and a base station to use QCL information for 3D beamforming in a holographic MIMO system. To select a 3D receive beam, the UE may receive control signaling from the base station indicating a QCL configuration associated with MIMO communications within a distance threshold from the base station (e.g., in the near field). For example, the base station may configure the UE with a transmission configuration indicator (TCI) state including the QCL configuration. The UE may receive an indication of a downlink transmission associated with the QCL configuration in the near field, and the UE may select a 3D beam in the near field to receive the downlink transmission based on the QCL configuration. In some examples, the UE may receive multiple repetitions of the downlink transmission using different receive beam configurations, and the UE may use the configurations to determine a beam weight configuration for the receive beam.

A method for wireless communication at a user equipment (UE) is described. The method may include receiving, from a base station, control signaling indicating a QCL configuration associated with MIMO communications within a distance threshold from the base station, receiving, from the base station, an indication of a downlink transmission associated with the QCL configuration within the distance threshold for MIMO communications from the base station, and selecting a beam to receive the downlink transmission within the distance threshold for MIMO communications from the base station based on the QCL configuration.

An apparatus for wireless communication at a UE is described. The apparatus may include a processor, memory in electronic communication with the processor, and instructions stored in the memory, where the instructions are executable by the processor to receive, from a base station, control signaling indicating a QCL configuration associated with MIMO communications within a distance threshold from the base station, receive, from the base station, an indication of a downlink transmission associated with the QCL configuration within the distance threshold for MIMO communications from the base station, and select a beam to receive the downlink transmission within the distance threshold for MIMO communications from the base station based on the QCL configuration.

Another apparatus for wireless communication at a UE is described. The apparatus may include means for receiving, from a base station, control signaling indicating a QCL configuration associated with MIMO communications within a distance threshold from the base station, means for receiving, from the base station, an indication of a downlink transmission associated with the QCL configuration within the distance threshold for MIMO communications from the base station, and means for selecting a beam to receive the downlink transmission within the distance threshold for MIMO communications from the base station based on the QCL configuration.

A non-transitory computer-readable medium storing code for wireless communication at a UE is described. The code may include instructions executable by a processor to receive, from a base station, control signaling indicating a QCL configuration associated with MIMO communications within a distance threshold from the base station, receive, from the base station, an indication of a downlink transmission associated with the QCL configuration within the distance threshold for MIMO communications from the base station, and select a beam to receive the downlink transmission within the distance threshold for MIMO communications from the base station based on the QCL configuration.

In some examples of the method, apparatuses, and non-transitory computer-readable medium described herein, receiving the control signaling may include operations, features, means, or instructions for receiving the control signaling configuring a TCI state including the QCL configuration associated with the MIMO communications within the distance threshold from the base station.

In some examples of the method, apparatuses, and non-transitory computer-readable medium described herein, receiving the indication of the downlink transmission may include operations, features, means, or instructions for receiving an indication of the TCI state via a radio resource control (RRC) message, a medium access control (MAC) control element (MAC-CE), or downlink control information (DCI).

In some examples of the method, apparatuses, and non-transitory computer-readable medium described herein, the control signaling includes a bit field indicating the TCI state may be associated with the receive beam used for MIMO communications within the distance threshold from the base station.

In some examples of the method, apparatuses, and non-transitory computer-readable medium described herein, receiving the indication of the downlink transmission may include operations, features, means, or instructions for receiving, from the base station, an indication of a set of multiple repetitions of the downlink transmission associated with the QCL configuration within the distance threshold for MIMO communications from the base station and receiving the set of multiple repetitions of the downlink transmission based on selecting the beam.

In some examples of the method, apparatuses, and non-transitory computer-readable medium described herein, receiving the set of multiple repetitions of the downlink transmission may include operations, features, means, or instructions for receiving the set of multiple repetitions of the downlink transmission using a corresponding set of multiple antenna combining weight configurations and determining a beam weight configuration for the beam to receive the downlink transmission based on receiving the set of multiple repetitions of the downlink transmission using the corresponding set of multiple antenna combining weight configurations.

Some examples of the method, apparatuses, and non-transitory computer-readable medium described herein may further include operations, features, means, or instructions for receiving, using the beam within the distance threshold from the base station, the downlink transmission including a periodic or semi-persistent channel state information reference signal (CSI-RS) and transmitting, to the base station, a CSI report based on receiving the periodic or semi-persistent CSI-RS.

Some examples of the method, apparatuses, and non-transitory computer-readable medium described herein may further include operations, features, means, or instructions for receiving, using the beam within the distance threshold from the base station, the downlink transmission including an aperiodic CSI-RS and transmitting, to the base station, a CSI report based on receiving the aperiodic CSI-RS.

Some examples of the method, apparatuses, and non-transitory computer-readable medium described herein may further include operations, features, means, or instructions for receiving, using the beam within the distance threshold from the base station, the downlink transmission including a physical downlink shared channel (PDSCH) message.

Some examples of the method, apparatuses, and non-transitory computer-readable medium described herein may further include operations, features, means, or instructions for receiving, using the beam within the distance threshold from the base station, the downlink transmission including a physical downlink control channel (PDCCH) message.

Some examples of the method, apparatuses, and non-transitory computer-readable medium described herein may further include operations, features, means, or instructions for receiving, from the base station, control signaling including an indication of a beam direction of a transmit beam from the base station and comparing the beam direction of the transmit beam to a position of the UE, where the beam may be selected to receive the downlink transmission based on the position of the UE correlating to the beam direction of the transmit beam.

In some examples of the method, apparatuses, and non-transitory computer-readable medium described herein, the indication of the beam direction may be an absolute positional value or a relative positional value associated with an antenna panel of the base station.

A method for wireless communication at a base station is described. The method may include transmitting, to a UE, control signaling indicating a QCL configuration associated with MIMO communications within a distance threshold from the base station, transmitting, to the UE, an indication of a downlink transmission associated with the QCL configuration within the distance threshold for MIMO communications from the base station, and transmitting, to the UE, the downlink transmission using a beam within the distance threshold for MIMO communications from the base station.

An apparatus for wireless communication at a base station is described. The apparatus may include a processor, memory in electronic communication with the processor, and instructions stored in the memory, where the instructions are executable by the processor to transmit, to a UE, control signaling indicating a QCL configuration associated with MIMO communications within a distance threshold from the base station, transmit, to the UE, an indication of a downlink transmission associated with the QCL configuration within the distance threshold for MIMO communications from the base station, and transmit, to the UE, the downlink transmission using a beam within the distance threshold for MIMO communications from the base station.

Another apparatus for wireless communication at a base station is described. The apparatus may include means for transmitting, to a UE, control signaling indicating a QCL configuration associated with MIMO communications within a distance threshold from the base station, means for transmitting, to the UE, an indication of a downlink transmission associated with the QCL configuration within the distance threshold for MIMO communications from the base station, and means for transmitting, to the UE, the downlink transmission using a beam within the distance threshold for MIMO communications from the base station.

A non-transitory computer-readable medium storing code for wireless communication at a base station is described. The code may include instructions executable by a processor to transmit, to a UE, control signaling indicating a QCL configuration associated with MIMO communications within a distance threshold from the base station, transmit, to the UE, an indication of a downlink transmission associated with the QCL configuration within the distance threshold for MIMO communications from the base station, and transmit, to the UE, the downlink transmission using a beam within the distance threshold for MIMO communications from the base station.

In some examples of the method, apparatuses, and non-transitory computer-readable medium described herein, transmitting the control signaling may include operations, features, means, or instructions for transmitting the control signaling indicating a TCI state including the QCL configuration associated with the MIMO communications within the distance threshold from the base station.

In some examples of the method, apparatuses, and non-transitory computer-readable medium described herein, transmitting the indication of the downlink transmission may include operations, features, means, or instructions for transmitting an indication of the TCI state via an RRC message, a MAC-CE, or DCI.

In some examples of the method, apparatuses, and non-transitory computer-readable medium described herein, the control signaling includes a bit field indicating the TCI state may be associated with the receive beam used for MIMO communications within the distance threshold from the base station.

In some examples of the method, apparatuses, and non-transitory computer-readable medium described herein, transmitting the indication of the downlink transmission may include operations, features, means, or instructions for transmitting, to the UE, an indication of a set of multiple repetitions of the downlink transmission associated with the QCL configuration within the distance threshold for MIMO communications from the base station and transmitting the set of multiple repetitions of the downlink transmission.

Some examples of the method, apparatuses, and non-transitory computer-readable medium described herein may further include operations, features, means, or instructions for transmitting, using the beam within the distance threshold from the base station, the downlink transmission including a periodic or semi-persistent CSI-RS and receiving, from the UE, a CSI report based on transmitting the periodic or semi-persistent CSI-RS.

Some examples of the method, apparatuses, and non-transitory computer-readable medium described herein may further include operations, features, means, or instructions for transmitting, using the beam within the distance threshold from the base station, the downlink transmission including an aperiodic CSI-RS and receiving, from the UE, a CSI report based on transmitting the aperiodic CSI-RS.

In some examples of the method, apparatuses, and non-transitory computer-readable medium described herein, transmitting the downlink transmission may include operations, features, means, or instructions for transmitting, using the beam within the distance threshold from the base station, the downlink transmission including a PDSCH message.

In some examples of the method, apparatuses, and non-transitory computer-readable medium described herein, transmitting the downlink transmission may include operations, features, means, or instructions for transmitting, using the beam within the distance threshold from the base station, the downlink transmission including a PDCCH message.

Some examples of the method, apparatuses, and non-transitory computer-readable medium described herein may further include operations, features, means, or instructions for transmitting, to the UE, control signaling including an indication of a beam direction of a transmit beam from the base station.

In some examples of the method, apparatuses, and non-transitory computer-readable medium described herein, the indication of the beam direction may be an absolute positional value or a relative positional value associated with an antenna panel of the base station.

### BRIEF DESCRIPTION OF THE DRAWINGS

FIG. 1 illustrates an example of a wireless communications system that supports quasi co-location (QCL) information for three dimensional (3D) beamforming in holographic multiple-input multiple-output (MIMO) systems in accordance with aspects of the present disclosure.

FIG. 2 illustrates an example of a wireless communications system that supports QCL information for 3D beamforming in holographic MIMO systems in accordance with aspects of the present disclosure.

FIGS. 3 and 4 illustrate examples of antenna combination schemes that support QCL information for 3D beamforming in holographic MIMO systems in accordance with aspects of the present disclosure.

FIG. 5 illustrates an example of a process flow that supports QCL for 3D beamforming in holographic MIMO systems in accordance with aspects of the present disclosure.

FIGS. 6 and 7 show block diagrams of devices that support QCL information for 3D beamforming in holographic MIMO systems in accordance with aspects of the present disclosure.

FIG. 8 shows a block diagram of a communications manager that supports QCL information for 3D beamforming in holographic MIMO systems in accordance with aspects of the present disclosure.

FIG. 9 shows a diagram of a system including a device that supports QCL information for 3D beamforming in holographic MIMO systems in accordance with aspects of the present disclosure.

FIGS. 10 and 11 show block diagrams of devices that support QCL information for 3D beamforming in holographic MIMO systems in accordance with aspects of the present disclosure.

FIG. 12 shows a block diagram of a communications manager that supports QCL information for 3D beamforming in holographic MIMO systems in accordance with aspects of the present disclosure.

FIG. 13 shows a diagram of a system including a device that supports QCL information for 3D beamforming in holographic MIMO systems in accordance with aspects of the present disclosure.

FIGS. 14 through 17 show flowcharts illustrating methods that support QCL information for 3D beamforming in holographic MIMO systems in accordance with aspects of the present disclosure.

### DETAILED DESCRIPTION

In some wireless communications systems (e.g., fifth generation (5G), New Radio (NR) systems), devices may be configured to communicate using beamforming techniques. For example, a base station may focus a transmission beam in the direction of a user equipment (UE) using two dimensional (2D) beamforming techniques. In some cases, the UE and the base station may perform multi-user (MU) multiple-input multiple-output (MIMO) communications to transmit or receive multiple signals via different spatial layers. The multiple signals may be transmitted or received via different antennas or different combinations of antennas. For example, the base station may maintain communications with a first UE via a first beam and communications via with a second UE via a second beam that is different than the first beam.

Some wireless communications systems may be configured to use beamforming techniques which may support both direction and distance discrimination in multiple-user MIMO (MU-MIMO) scenarios. For example, the base station may be configured to perform three dimensional (3D) beamforming techniques, where the base station may form transmission beams using different antenna panels to UEs that may distinguish both direction and distance between the UEs and the base station. In some cases, the base station may be configured to perform 3D holographic MIMO in which the base station may multiplex UEs otherwise unsupported for multiplexing (e.g., if the base station were to use 2D beamforming techniques). In some cases, a 3D beam may have different effectiveness to UEs in the near field (e.g., within a distance threshold of MIMO communications from the base station) and UEs in the far field (e.g., outside of the distance threshold of MIMO communications from the base station). For example, receive antenna combining and beamforming weights may be different in the far field (e.g., using a 2D beam) and in the near field (e.g., using a 3D beam). When a UE moves locations, a 3D receive beam used by the UE to receive 3D beamformed transmissions may change. Some techniques for determining a 3D receive beam may increase radio resource consumption and increase system latency, and as such, the UE may be unable to maintain a real-time 3D receive beam when the UE moves. For example, if a data transmission on a 3D transmit beam is scheduled for the UE, the UE may perform a long beam determination procedure based on positioning information of the UE, increasing latency for the 3D beamformed signaling.

Techniques described herein enable a UE and a base station to use quasi co-location (QCL) information for 3D beamforming in a holographic MIMO system. To select a 3D receive beam, the UE may receive control signaling from the base station indicating a QCL configuration associated with MIMO communications within a distance threshold from the base station (e.g., in the near field). If the UE is scheduled or configured for signaling associated with the QCL configuration, the signaling may be transmitted using a 3D transmit beam. For example, the base station may configure the UE with a transmission configuration indicator (TCI) state including the QCL configuration. The UE may receive an indication of a downlink transmission and the TCI state for the downlink transmission, and the UE may select a 3D beam in the near field to receive the downlink transmission based on the QCL configuration. In some examples, the UE may receive multiple repetitions of the downlink transmission using different receive beam configurations, and the UE may determine a beam weight for the 3D receive beam based on receiving the repetitions with the different receive beam configurations.

Particular aspects of the subject matter described herein may be implemented to realize one or more advantages. The described techniques may support improvements in 3D beamforming in a holographic MIMO system by enabling the UE to use QCL information to select a receive 3D beam. In some examples, the techniques described herein may reduce latency in beam determination and reduce radio resource consumption, thereby improving the performance of channel state information (CSI) estimation and downlink reception for UEs in the near field. As such, supported techniques may include improved network operations, and, in some examples, may promote network efficiencies, among other benefits.

Aspects of the disclosure are initially described in the context of wireless communications systems. Aspects of the disclosure are then described in the context of antenna combination schemes and a process flow. Aspects of the disclosure are further illustrated by and described with reference to apparatus diagrams, system diagrams, and flowcharts that relate to QCL information for 3D beamforming in holographic MIMO systems.

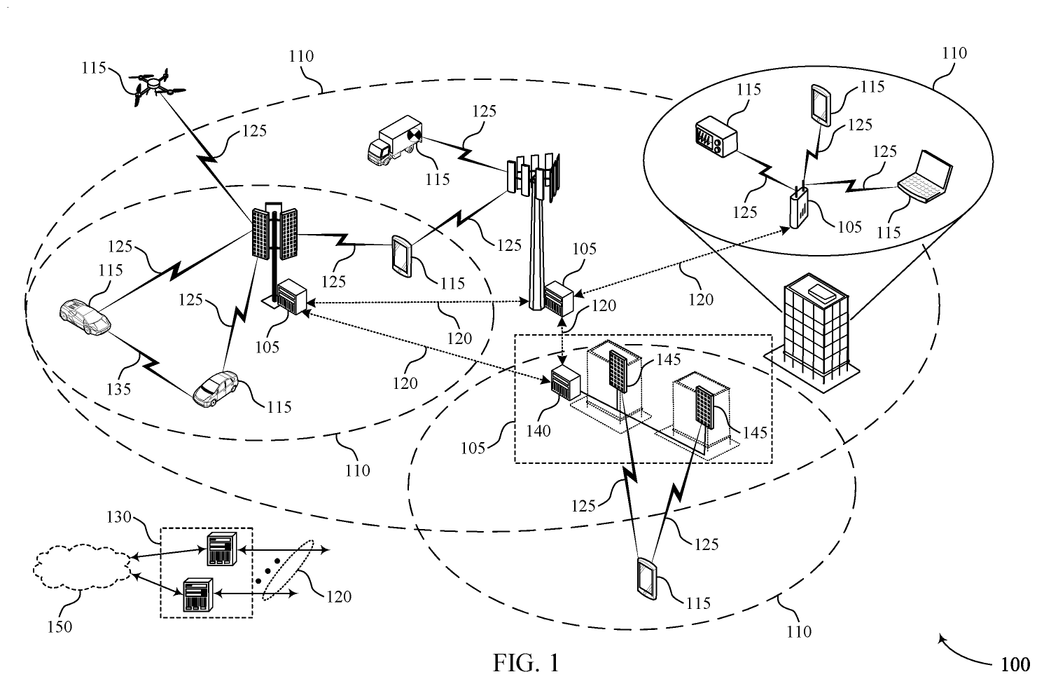

FIG. 1 illustrates an example of a wireless communications system 100 that supports QCL information for 3D beamforming in holographic MIMO systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz. (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and MU-MIMO, where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, a UE 115 and a base station 105 may use QCL information for 3D beamforming in a holographic MIMO system. To select a 3D receive beam, the UE 115 may receive control signaling from the base station 105 indicating a QCL configuration associated with MIMO communications within a distance threshold from the base station 105 (e.g., in the near field). For example, the base station 105 may configure the UE 115 with a TCI including the QCL configuration. The UE 115 may receive an indication of a downlink transmission associated with the QCL configuration in the near field, and the UE 115 may select a 3D beam in the near field to receive the downlink transmission based on the QCL configuration. In some examples, the UE 115 may receive multiple repetitions of the downlink transmission using different receive beam configurations, and the UE 115 may use the configurations to determine the beam weight for the receive beam.

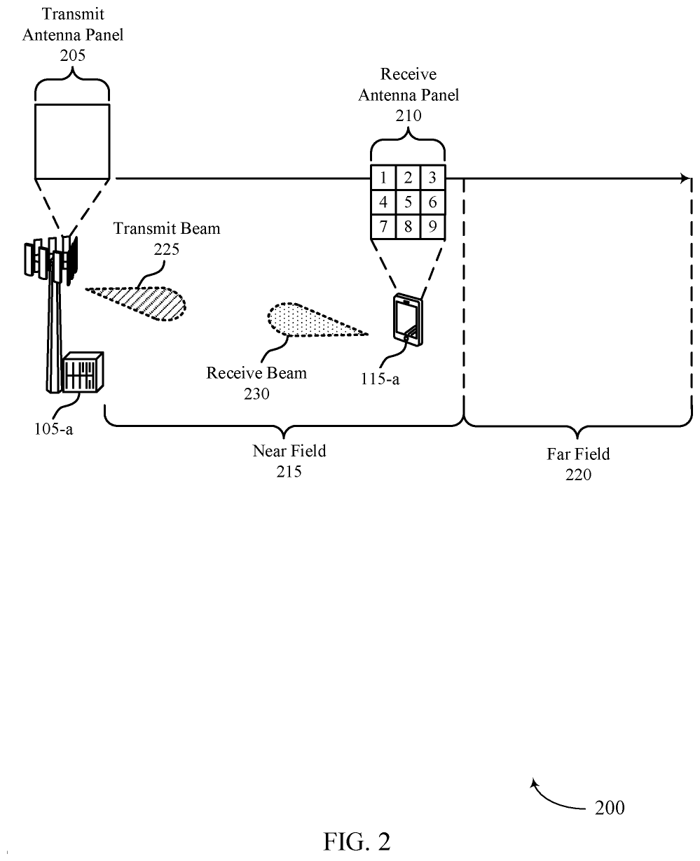

FIG. 2 illustrates an example of a wireless communications system 200 that supports QCL information for 3D beamforming in holographic MIMO systems in accordance with aspects of the present disclosure. In some examples, the wireless communications system 200 may implement aspects of the wireless communications system 100 or may be implemented by aspects of the wireless communications system 100. For example, the wireless communications system 200 may include a UE 115-a and a base station 105-a. which may be examples of corresponding devices described herein with reference to FIG. 1. The wireless communications system 200 may include features for improved communications between the UE 115-a and the base station 105-a, among other benefits.

The base station 105-a and the UE 115-a may be configured to transmit and receive signaling using one or more antenna panels. For example, the base station 105-a may use the transmit antenna panel 205 to transmit signaling to the UE 115-a, and the UE 115-a may receive the signaling from the base station 105-a using the receive antenna panel 210. In some cases, the base station 105-a may be configured to use 2D beamforming techniques using an antenna array, which may be included the transmit antenna panel 205. 22D beamforming may concentrate transmission power to a direction described by angles in azimuth and zenith (e.g., azimuth angles of departure (AoD)/azimuth angles of arrival (AoA), zenith angles of departure (ZoD)/zenith angles of arrival (ZoA)). In some cases, 2D beamforming may create a low MU-MIMO opportunity, may lack the ability to discriminate UEs 115 located in the same direction and different distances, and thus may lack the ability to pair the UEs 115 for MU-MIMO transmission. This may result in restricted MU pairing opportunities and MU diversity gain and reduced cell-level spectral efficiency. In some cases, 2D beamforming may also lead to low transmission power utilization efficiency. A 2D beam may cover the whole area of some angle, but a target UE (e.g., the UE 115-a ) may be located at one spot area with a particular distance from the base station 105-a. Thus, the transmission power landing at the areas with other distances may be wasted.

The wireless communications system 200 may be configured to use beamforming techniques which may support both direction and distance discrimination in MU-MIMO scenarios. In some cases, the base station 105-a may be configured to perform 3D holographic MIMO, in which the base station 105-a may multiplex UEs (e.g., the UE 115-a ) otherwise unsupported for multiplexing (e.g., if the base station 105-a were to use 2D beamforming techniques). The base station 105-a may perform holographic MIMO (e.g., holographic massive MIMO) with an active surface located at the base station 105-a which may generate a radio frequency signal at the backside of the surface, and where the radio frequency signal may propagate through a steerable distribution network to radiating elements that may generate a beam, such as a near field beam or a far field beam. In some examples, holographic MIMO may be performed with a passive surface located at a different location than the base station 105-a, where the radio frequency signal may be sent from another location and a metasurface may reflect the radio frequency signal using steerable elements that may generate the beam.

In some cases in which the base station 105-a may perform 3D holographic MIMO, the coverage area close to transmit antenna panel 205 of the base station 105-a may be a near field 215 (e.g., supported by a transmit beam 225 and a receive beam 230), while the coverage area far away from the transmit antenna panel 205 of the base station 105-a may be a far field 220. When the distance of a coverage area is sufficiently short (e.g., relative to the size of the transmit antenna panel 205), the generated beam to this area may have holographic characteristics. For example, the transmit beam 225 and the receive beam 230 may have holographic characteristics in the near field 215 if the near field 215 is relatively close to the transmit antenna panel 205. In some cases, the beam may be capable of distinguishing direction and distance, and as such the beam may be a 3D beam or a holographic beam. The 3D beam may cover an angular range and a distance range. When the base station 105-a utilizes one or more 3D beams to transmit one or multiple data streams, the base station 105-a may use a holographic MIMO system. In some cases, a 3D beam in the near field 215 (e.g., ≤50 m from the transmit antenna panel 205) may have a larger beamforming gain (e.g., reference signal received power (RSRP) gain) than a 2D beam, however the 2D beam may have a larger coverage area than the 3D beam.

3D beamforming may create a high MU-MIMO opportunity, may discriminate UEs 115 with the same direction and different distances, and may pair the UEs 115 for MU-MIMO transmission (e.g., as opposed to 2D beamforming, which may lack the ability to discriminate between UEs 115 with the same direction and difference distances). The high MU-MIMO opportunity may result in enhanced MU pairing opportunities and MU diversity gain, as well as improved cell-level spectral efficiency. In some cases, 3D beamforming may also introduce high transmission power utilization efficiency. The 3D beam may cover the area of the target UE (e.g., the UE 115) in terms of both direction and distance, thus, the transmission power landing at the areas with other angles or distances may be minimized, so the transmission power utilization efficiency may be improved.

The base station 105-a, with an antenna array (e.g., the transmit antenna panel 205), may be configured to perform 3D holographic MIMO where the base station 105-a may form transmission beams to UEs 115 that may distinguish both direction and distance between the UEs 115 and the base station 105-a. In some examples, the near field 215 may be within a distance threshold of MIMO communications from the base station 105-a and the far field 220 may be outside of a distance threshold of MIMO communications from the base station 105-a. In some cases, the partitioning distance of the near field 215 (e.g., which may be further divided as a reactive near field and a radiating near field) and the far field 220 may depend on an antenna panel size D (e.g., the length of the transmit antenna panel 205) and a signal wavelength λ. In some cases, the near field 215 may cover a distance from 0 m to 2D²/λm with respect to the transmit antenna panel 205, where the reactive near field may cover a distance from 0 m to 0.62\sqrt{D³/λ}m and the radiative near field may cover a distance from 0.62\sqrt{D³/λ}m to 2D²/λm. The far field 220 may cover a distance from 2D²/λm to ∞ with respect to the transmit antenna panel 205.

The near field 215 may include one or more UEs 115 (e.g., the UE 115-a ), which may each be served by a 3D receive beam (e.g., the receive beam 230). The UEs 115 in the near field 215 may communicate with the base station 105-a using holographic MIMO beamforming. The far field 220 may include different UEs 115, which may each be served by a 2D beam pointing to each UE 115. The UEs 115 in the far field 220 may communicate with the base station 105-a using NR MIMO beamforming techniques. As the sizes of the near field 215 and the far field 220 depend on wavelength, the area of the near field 215 may become larger with higher frequency bands.

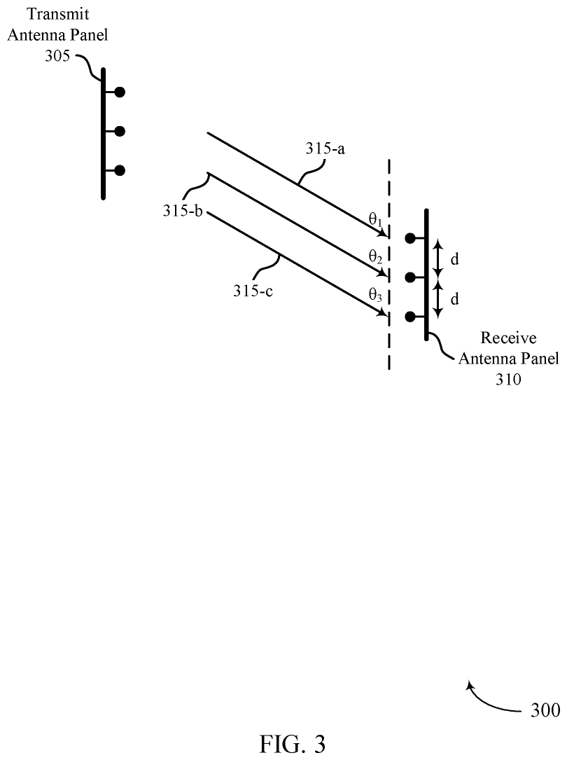

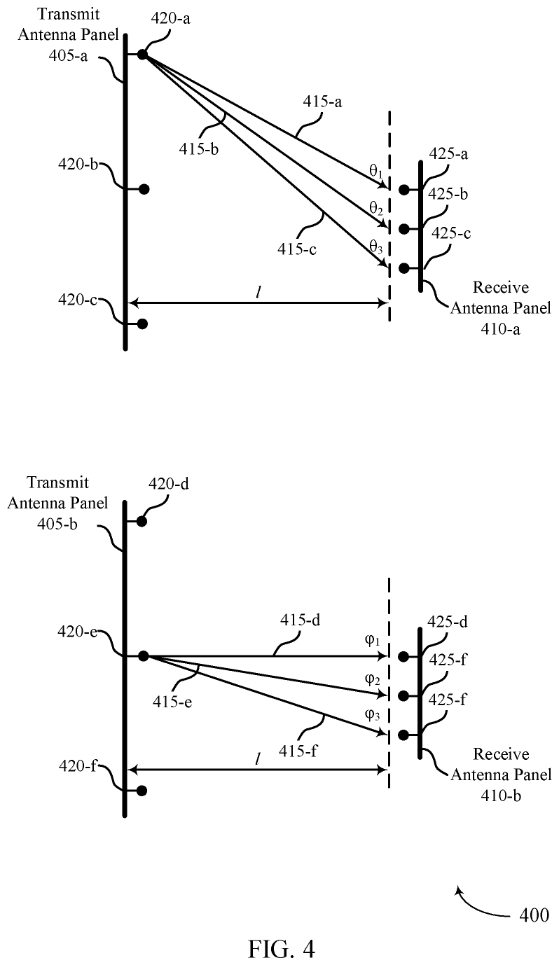

In some cases, receive antenna combining may differ for the far field 220 and the near field 215, which is described in more detail with respect to FIGS. 3 and 4. As such, some UEs 115 in other systems may lack techniques for receive beam determination (e.g., combining beam weights) to receive a transmission sent from a base station 105 on a 3D transmit beam. Additionally, or alternatively, a UE 115 may be unable to maintain a real-time 3D receive beam when the UE 115 is moving.

A 3D transmit beam may have a small coverage area compared to that of a 2D transmit beam, so the base station 105-a may use a 2D transmit beam to track the UE 115-a. The 2D transmit beam may have a relatively large coverage area, so the UE 115-a may maintain a real-time receive beam (e.g., a 2D receive beam) to receive the 2D transmit beam when the UE 115-a moves. However, when the UE 115-a locates to different positions in the near field 215, the receive beam 230 may change with the location of the UE 115-a. Therefore, the UE 115-a may be unable to receive 3D beamformed signaling without determining a new 3D receive beam. In some cases, determining the receive beam 230 may be a high latency process which uses significant radio resources. As such, without scheduled data transmissions as the UE 115-a moves, it may be costly (e.g., power, time, and resource expensive) for the UE 115-a to maintain a real-time 3D receive beam when the UE 115-a moves.

The base station 105-a may indicate that a transmission is scheduled for a 3D transmit beam so that the UE 115-a can select a 3D receive beam. For example, when the base station 105-a schedules a data transmission for a 3D transmit beam after the UE 115-a has moved, the base station 105-a may need to inform the UE 115-a to determine a 3D receive beam in real-time. A 3D transmit beam may be based on a current and precise 3D position of the UE 115-a, and the UE 115-a may not have stored receive beam weights for a current position, or the UE 115-a may not store receive beam weights for some previous positions. Therefore, the UE 115-a may first determine a configuration (e.g., beam weights) for the 3D receive beam in order to receive the 3D transmit beam. Additionally, or alternatively, some QCL types (e.g., a QCL type-D) in some systems may fail to indicate to a UE 115 whether a scheduled transmission uses a 2D transmit beam or a 3D transmit beam. Without this information, the UE 115 may fail to select a proper 3D receive beam.

The wireless communications system 200 may implement techniques for efficient real-time 3D beam determinations. For example, the wireless communications system 200 may support QCL information and QCL associations for 3D beamformed communications. The base station 105-a may transmit QCL information to the UE 115-a to indicate whether a downlink transmission is a 3D beam-based transmission. For example, the QCL information may include a QCL type (e.g., a type-E) which indicates that an associated physical downlink control channel (PDCCH), a physical downlink shared channel (PDSCH), or CSI-RS may be transmitted by the transmit beam 225 (e.g., a 3D transmit beam).

In some cases, the base station 105-a may configure the UE 115-a with a TCI state that includes the QCL association. The base station 105-a may include a TCI state indicator (ID) corresponding to the TCI state in an RRC message, a MAC control element (MAC-CE), or downlink control information (DCI) which configures or schedules another downlink transmission. For example, the base station 105-a may include the TCI indicator in signaling to configure a periodic or semi-persistent CSI-RS, schedule a PDSCH (e.g., with demodulation reference signals (DMRS)), schedule an aperiodic CSI-RS, or configure or schedule PDCCH signaling or a control resource set. The TCI state indicator may indicate that the configured or scheduled downlink transmission is transmitted using the transmit beam 225 (e.g., a 3D transmit beam) based on the QCL association, and the UE 115-a may determine to perform real-time 3D receive beam training to receive the downlink transmission.

In some cases, the base station 105-a may reuse an existing QCL type (e.g., QCL type-D), and the base station 105-a may include an indicator (e.g., an additional bit field) indicating whether the transmit beam 225 is used in the near field 215 (e.g., a 3D beam) or the far field 220 (e.g., a 2D beam). After detecting the TCI state ID and indicator (e.g., indicating that the transmit beam 225 is a 3D transmit beam), the UE 115-a may determine (e.g., select) a proper 3D receive beam to receive the associated PDSCH or CSI-RS.

In some examples, the scheduled downlink transmission may be transmitted or repeated multiple times for the UE 115-a to perform 3D receive beam determining. For example, a CSI-RS or DMRS may be transmitted or repeated multiple times with the same transmit beam 225. For example, if the receive antenna panel 210 has nine receive antenna elements, the base station 105-a may transmit ten repetitions of a reference signal (e.g., the CSI-RS or the DMRS). In some cases, the base station 105-a may transmit one scheduling grant to schedule multiple repetitions of the downlink transmission, or the base station 105-a may transmit separate scheduling grants for the repetitions. The UE 115-a may determine a 3D receive beam (e.g., the receive beam 230) based on the CSI-RS or the DMRS by using a measurement-based receive beam determination (e.g., receive combining) procedure.

In some cases, the UE 115-a may perform the beam determination for a narrow beam (e.g., P3 stage of beam management). The receive antenna panel 210 of the UE 115-a may include a quantity of receive antenna elements (e.g., nine receive antenna elements). For each receive antenna element of the receive antenna panel 210, the UE 115-a may receive the same signal from the base station 105-a twice with a pair of flip-over antenna combining weights. As such, the UE 115-a may obtain a signal amplitude and phase for each receive antenna element in the receive antenna panel 210.

The UE 115-a may use receive weights to receive the transmitted signals. For example, the UE 115-a may use the receive weights w₀=[1, 1, 1, . . . , 1], w₁=[1, −1, −1, . . . , −1], w₂=[−1, 1, −1, . . . , −1], . . . , through w_{N}=[−1, −1, −1, . . . , 1] to receive the different repetitions. The UE 115-a may add the combined signals each with combining weights w₀ and wᵢ, where the output result may be the channel response value at the ith element given as

$$\frac{{w}_{0} y + {w}_{i} y}{2 x} = \frac{( {\sum }_{j = 1}^{N} {y}_{j} ) + ( {y}_{i} - {\sum }_{j = 1 , j \neq i}^{N} {y}_{j} )}{2 x} = \frac{{y}_{i}}{x} = ,$$

where x may represent a reference signal and y may represent the received signal on the whole receive antenna panel 210. Using this procedure, the obtained receive beamforming (e.g., combining) weight may be described as [exp(−j·phase( [symbol] )), . . . , exp(−j·phase( [symbol] ))]. To estimate the signal amplitudes and phases of N elements, the same transmit beams may be transmitted N+1 times.

The base station 105-a may transmit reference signals, data transmissions, or both to the UE 115-a to enable the UE 115-a to determine a 3D receive beam. In some cases, the base station 105-a (e.g., which may support holographic MIMO communications) may transmit a control message to the UE 115-a to configure a TCI state that includes a QCL type for 3D beamformed communications. The control message may be a higher layer message, such as an RRC message. The base station 105-a may configure, or activate, a periodic or a semi-persistent CSI-RS resource associated with a TCI state ID of the TCI state via an RRC message, a MAC-CE, or both. The base station 105-a may then transmit the periodic or the semi-persistent CSI-RS (e.g., the repetitions of the periodic or semi-persistent CSI-RS) using the transmit beam 225 (e.g., a 3D transmit beam) to the UE 115-a, and the UE 115-a may determine the receive beam 230 (e.g., a 3D receive beam). In some cases, the UE 115-a may transmit a report to the base station 105-a indicating CSI associated with the receive beam 230.

Some examples may support 3D receive beam determination based on PDSCH signaling and DMRS in the PDSCH. For example, the base station 105-a may transmit a control message to the UE 115-a to configure a TCI state that includes a QCL type for 3D beamformed communications. The base station 105-a may configure, or activate, an aperiodic CSI-RS resource associated with the TCI state in a MAC-CE, DCI, or both. The base station 105-a may then transmit the aperiodic CSI-RS (e.g., the repetitions of the aperiodic CSI-RS) using the transmit beam 225 to the UE 115-a, and the UE 115-a may determine the receive beam 230. In some cases, the UE 115-a may transmit a report to the base station 105-a indicating CSI associated with the receive beam 230.

Some examples may support 3D receive beam determination based on PDSCH signaling, such as based on DMRS transmitted on PDSCH resources. For example, the base station 105-a may transmit a control message to the UE 115-a to configure a TCI state that includes a QCL type for 3D beamformed communications. The base station 105-a may configure or schedule PDSCH resources associated with the TCI state via a MAC-CE, DCI, or both. The base station 105-a may then transmit PDSCH signaling (e.g., including DMRS) using the transmit beam 225 to the UE 115-a, and the UE 115-a may determine the receive beam 230. In some cases, the PDSCH signaling may include a data transmission for the UE 115-a. In some cases, the UE 115-a may decode the PDSCH with the receive beam 230).

Some examples may support 3D receive beam determination based on PDCCH signaling or control signaling in a control resource set. For example, the base station 105-a may transmit a control message to the UE 115-a to configure a TCI state that includes a QCL type associated with 3D beamformed communications. The base station 105-a may configure PDCCH resources or a CORESET, or both, associated with the TCI state via an RRC-layer message, a MAC-CE, or both. The base station 105-a may then transmit on the PDCCH resources or the control resource set, or both, using the transmit beam 225 to the UE 115-a, and the UE 115-a may determine the receive beam 230. In some cases, the UE 115-a may decode the PDCCH signaling with the receive beam 230.

In some cases, the base station 105-a may indicate a target position value of a 3D beam. In some examples, the target position value of the 3D beam may be indicated in, or included with, the QCL indication. In some cases, the position value may be an absolute value, such as specific positioning or directional information. In some cases, the position value may be a relative value, such as positioning information based on a distance from and angle relative to the transmit antenna panel 205. The UE 115-a may determine its own position, and the UE 115-a may compare its position with the indicated target position. If the UE 115-a is located in front of the target position (e.g., if the distance between the base station 105-a and the UE 115-a is larger than the distance between the base station 105-a and the target position), the UE 115-a may regard the beam as a 2D transmit beam and may receive a transmission from the base station 105-a with a 2D receive beam. If the UE 115-a is located behind the target position, the UE 115-a may regard the beam as a 3D transmit beam and the UE 115-a may receive the transmission from the base station 105-a with the receive beam 230 (e.g., a 3D receive beam). In some examples, the UE 115-a may be configured with a range (e.g., a margin) for using the 3D receive beam and using the 2D receive beam. For example, if the UE 115-a is within the configured range of the indicated target position value, the UE 115-a may determine to use the 2D receive beam or the 3D receive beam.

These techniques may provide fast 3D receive beam determination at a wireless device, such as the UE 115-a. By indicating QCL information for a 3D transmit beam, the UE 115-a may measure CSI-RS or decode PDSCH or PDCCH signaling using a 3D receive beam with calculated beam weights. This may reduce the latency of 3D receive beam determination, as the UE 115-a may perform the 3D beam determination on scheduled signaling. Additionally, or alternatively, the UE 115-a may perform the 3D beam determination on reference signals, which may improve CSI estimation.

FIG. 3 illustrates an example of an antenna combination scheme 300 that supports QCL information for 3D beamforming in holographic MIMO systems in accordance with aspects of the present disclosure. In some examples, the antenna combination scheme 300 may implement aspects of the wireless communications systems 100 and 200 or may be implemented by aspects of the wireless communications systems 100 and 200. For example, the antenna combination scheme 300 may include a transmit antenna panel 305 and a receive antenna panel 310, which may be associated with a UE 115 and a base station 105 as described herein with reference to FIGS. 1 and 2.

In some cases, receive antenna combining (e.g., receive beamforming) may differ for UEs 115 the far field and the near field from a base station 105. For example, receive antenna combining and receive beamforming weights may be different between a far field beam (e.g., a 2D beam) and a near field beam (e.g., a 3D beam). In some cases, the base station 105 may transmit signaling to a UE 115 using the transmit antenna panel 305, and the UE 115 may receive the signaling from the base station 105 using the receive antenna panel 310. In some examples, the transmit antenna panel 305 and the receive antenna panel 310 may each include a quantity of antenna elements (e.g., three antenna elements), the inter-element distance in the receive antenna panel 310 may be a distance d.

In the far field, the base station 105 may transmit signals 315 from any antenna element of the transmit antenna panel 305 to any element of the receive antenna panel 310, and each signal 315 may have the same arrival angle θ at the receive antenna panel 310 (e.g., because the transmit antenna panel 305 and the receive antenna panel 310 are sufficiently far away from each other). For example, the base station 105 may transmit a signal 315-a, a signal 315-b, and a signal 315-c from the transmit antenna panel 305 which may each arrive at the receive antenna panel 310 at an angle θ₁, θ₂, and θ₃ respectively, where θ₁=θ₂=θ₃. In some cases, the base station and the UE 115 may use an identical DFT-based beam weight on each signal to guarantee co-phase combining of the signals arriving at the receive antenna panel 310 from any element of the transmit antenna panel 305. In some cases, the receive combining weight vector may be given as

$$[ 1 , {e}^{- j \frac{2 π dsin {θ}_{1}}{λ}} , … , {e}^{- j \frac{2 π ( N - 1 ) dsin {θ}_{1}}{λ}} ]$$

with linearly increasing phases, where N is the number of receive antenna elements.

Wireless devices described herein may implement techniques to indicate that a scheduled downlink transmission is transmitted using a 3D transmit beam. For example, a UE 115 may determine a 2D receive beam according to the antenna combination scheme 300. A base station 105 may use a 2D transmit beam while the UE 115 moves within a coverage area of the base station 105. However, when the UE 115 moves, a 3D receive beam configuration at the UE 115 may change. The base station 105 may use the 2D transmit beam to schedule the UE 115 for a 3D beamformed transmission, and the base station 105 may indicate that the scheduled transmission is transmitted using a 3D transmit beam. For example, when the base station 105 schedules or configures the transmission, the base station 105 may indicate a TCI state associated with 3D beamformed communications. The UE 115 may then perform a 3D beam receive determination technique on the scheduled signaling to determine beam weights for a 3D receive beam.

FIG. 4 illustrates an example of an antenna combination scheme 400 that supports QCL information for 3D beamforming in holographic MIMO systems in accordance with aspects of the present disclosure. In some examples, the antenna combination scheme 400 may implement aspects of the wireless communications systems 100 and 200 or may be implemented by aspects of the wireless communications systems 100 and 200. For example, the antenna combination scheme 400 may include transmit antenna panels 405 and receive antenna panels 410, which may be associated with a UE 115 and a base station 105 as described herein with reference to FIGS. 1 and 2.

In some cases, receive antenna combining (e.g., receive beamforming) may differ for UEs 115 the far field and the near field from a base station. For example, receive antenna combining and receive beamforming weights may be different between a far field beam (e.g., a 2D beam) and a near field beam (e.g., a 3D beam). In some cases, the base station 105 may transmit signaling to a UE 115 using a transmit antenna panel 405, and the UE 115 may receive the signaling from the base station 105 using a receive antenna panel 410.

In the near field, the base station 105 may transmit signals 415 from one transmit antenna element 420 of the transmit antenna panel 405-a to multiple receive antenna elements 425 of the receive antenna panel 410-a such that each signal 415 may have a different arrival angle (e.g., a spherical wave). The transmit antenna panel 405-a and the receive antenna panel 410-a may be separated by a distance l. The transmit antenna panel 405-a may include a transmit antenna element 420-a, a transmit antenna element 420-b, and a transmit antenna element 420-c, and the receive antenna panel 410-a may include a receive antenna element 425-a, a receive antenna element 425-b, and a receive antenna element 425-c. The base station 105 may transmit the signals 415 from the transmit antenna element 420-a, which each may arrive at different receive antenna elements 425 and at different angles θ. For example, a signal 415-a may arrive at the receive antenna element 425-a at θ₁, a signal 415-b may arrive at the receive antenna element 425-b at θ₂, and a signal 415-c may arrive at the receive antenna element 425-c at θ₃, where θ₁≠θ₂≠θ₃.

In some examples, the base station 105 may transmit signals 415 from one transmit antenna element 420 of a transmit antenna panel 405-b to multiple receive antenna elements 425 of a receive antenna panel 410-b such that each signal 415 may have a different arrival angle (e.g., a spherical wave). The transmit antenna panel 405-b and the receive antenna panel 410-b may be separated by a distance l. The transmit antenna panel 405-b may include a transmit antenna element 420-d, a transmit antenna element 420-e, and a transmit antenna element 420-f, and the receive antenna panel 410-b may include a receive antenna element 425-d, a receive antenna element 425-e, and a receive antenna element 425-f. The base station 105 may transmit the signals 415 from the transmit antenna element 420-e, which each may arrive at different receive antenna elements 425 and at different angles φ. For example, a signal 415-d may arrive at the receive antenna element 425-d at φ₁, a signal 415-e may arrive at the receive antenna element 425-e at φ₂, and a signal 415-f may arrive at the receive antenna element 425-f at φ₃, where φ₁≠φ₂≠φ₃.

For each transmit antenna element 420, the arrival angles of the signals 415 at an array of receive antenna elements 425 may be mostly unequal (e.g., θ₁≠θ₂≠θ₃, φ₁≠φ₂≠φ₃). In some cases, for each receive antenna element 425, the arrival angles of signals 415 from any two transmit antenna elements 420 may be mostly unequal (e.g., θᵢ≠φᵢ, i=1˜3). As such, using DFT-based weights may fail to enable co-phase combining of the signals 415 arriving from any transmit antenna element 420. In some cases, the receive combining weight vector for the transmit antenna element 420-a or the transmit antenna element 420-b (e.g., transmit antenna element 1 or transmit antenna element 2) may be given

$$[ 1 , {e}^{- j \frac{2 π l}{λ sin {θ}_{1}}} , … , {e}^{- j \frac{2 π l}{{λ sin θ}_{N}}} ] or [ 1 , {e}^{- j \frac{2 π l}{{λ sin ϕ}_{1}}} , … , {e}^{- j \frac{2 π l}{{λ sin ϕ}_{N}}} ] ,$$

as instead of DFT beams, where N is the number of receive antenna elements. As such, the system may lack a receive combining weight vector for all transmit antenna elements 420.

The UE 115 may determine a 3D receive beam (e.g., perform receive combining) by using a measurement-based receive beam determination (e.g., receive combining) procedure as described with reference to FIG. 2. For each receive antenna element 425 of a receive antenna panel 410, the UE 115 may receive the same signal 415 from the base station twice with a pair of flip-over antenna combining weights. As such, the UE 115 may obtain a signal amplitude and phase for each receive antenna element 425 in a receive antenna panel 410.

The UE may use receive weights to receive the same transmitted signals. For example, the UE may use the receive weights w₀=[1, 1, 1, . . . , 1], w₁=[1, −1, −1, . . . , −1], w₂=[−1, 1, −1, . . . , −1], . . . , or w_{N}=[−1, −1, −1, . . . , 1]. The UE may add the combined signals each with combining weights w₀ and wᵢ, where the output result may be the channel response value at the ith element given as

$$\frac{{w}_{0} y + {w}_{i} y}{2 x} = \frac{( {\sum }_{j = 1}^{N} {y}_{j} ) + ( {y}_{i} - {\sum }_{j = 1 , j \neq i}^{N} {y}_{j} )}{2 x} = \frac{{y}_{i}}{x} = ,$$

where x may represent a reference signal and y may represent the received signal 415 on the whole receive antenna panel 410. Using this procedure, the obtained receive beamforming (e.g., combining) weight may be described as [exp(−phase( [symbol] )), . . . , exp(−phase( [symbol] ))].

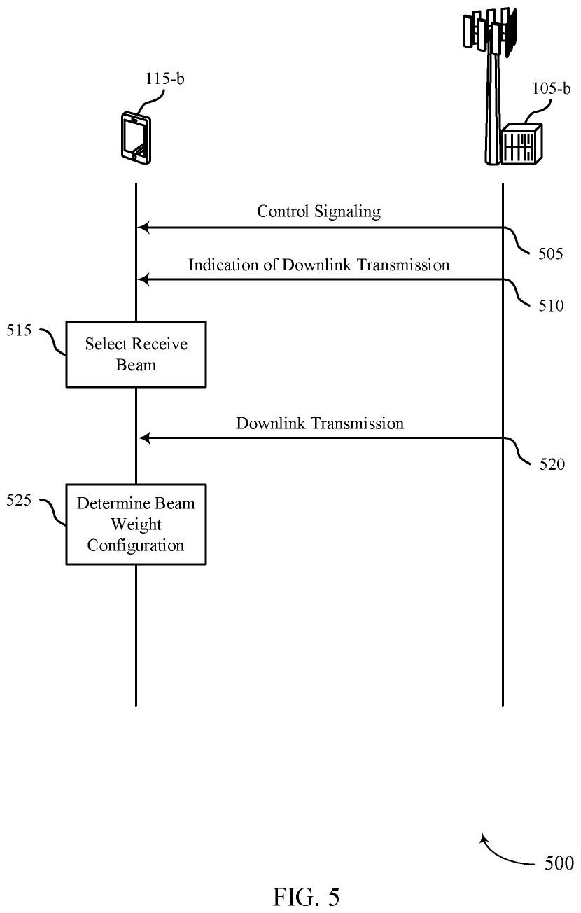

FIG. 5 illustrates an example of a process flow 500 that supports QCL information for 3D beamforming in holographic MIMO systems in accordance with aspects of the present disclosure. The process flow 500 may implement aspects of wireless communications systems 100 and 200 or may be implemented by aspects of the wireless communications system 100 and 200. For example, the process flow 500 may illustrate operations between a UE 115-b and a base station 105-b, which may be examples of corresponding devices described with reference to FIGS. 1 and 2. In the following description of the process flow: 500, the operations between the UE 115-b and the base station 105-a may be transmitted in a different order than the example order shown, or the operations performed by the UE 115-b and the base station 105-b may be performed in different orders or at different times. Some operations may also be omitted from the process flow 500, and other operations may be added to the process flow: 500.

At 505, the UE 115-b may receive, from the base station 105-b, control signaling indicating a QCL configuration associated with MIMO communications within a distance threshold from the base station 105-b (e.g., in the near field). In some cases, the control signaling may configure the UE 115-b with a TCI state including the QCL configuration. In some cases, signaling associated with the QCL configuration may be transmitted by the base station 105-b via a 3D transmit beam. In some cases, the QCL indication may include an additional field that may indicate whether a transmit beam is targeted for near field communications (e.g., a 3D beam) or far field communications (e.g., a 2D beam). In some cases, the QCL configuration may be an example of, or include, a QCL Type-D association or a QCL Type-E association described herein. In some cases, the additional bit field may be used with the QCL Type-D association to indicate that the TCI state is associated with 3D beamformed communications.

At 510, the UE 115-b may receive, from the base station 105-b, an indication of a downlink transmission associated with the QCL configuration within the distance threshold for MIMO communications from the base station. For example, the base station 105-b may configure or schedule downlink signaling, and the base station 105-b may indicate the TCI state including the QCL configuration associated with 3D beamforming when configuring or scheduling the downlink signaling. The UE 115-b may receive the indication of the downlink transmission, determine that the downlink transmission is configured for the TCI state including the QCL configuration, and determine that the downlink transmission is to be transmitted by the base station 105-b using a 3D transmit beam. Therefore, the UE 115-b may determine to perform the 3D receive beam determination on the downlink transmission associated with the QCL configuration. The base station 105-b may transmit, for example, an RRC message, a MAC CE, or DCI, or any combination thereof, to indicate (e.g., configure or schedule) the downlink transmission.

The downlink transmission may be, for example, a periodic CSI-RS, a semi-persistently scheduled CSI-RS, an aperiodic CSI-RS, a data transmission on PDSCH resources, a control message on PDCCH resources, a control resource set, or any combination thereof. The UE 115-b may determine to perform the 3D receive beam determination on the CSI-RS (e.g., periodic, aperiodic, or semi-persistent), DMRS transmitted on the PDSCH resources, or signaling which is associated with the QCL configuration based on the indication of the downlink transmission or an indication of the TCI state, or both.

At 515, the UE 115-b may select a beam to receive the downlink transmission within the distance threshold for MIMO communication from the base station based on the QCL configuration. For example, the UE 115-b may select a 3D receive beam to receive the downlink transmission based on the downlink transmission being transmitted by a 3D transmit beam.

At 520, the UE 115-b may receive, from the base station, the downlink transmission using a beam within the distance threshold for MIMO communications from the base station (e.g., a 3D receive beam). In some cases, the UE 115-b may receive one or more repetitions of the downlink transmission based on selecting the receive beam, and the UE 115-b may receive the one or more repetitions of the downlink transmission using a corresponding one or more antenna combining weight configurations.

At 525, the UE 115-b may determine a beam weight configuration of the beam to receive the downlink transmission based on receiving the one or more repetitions of the downlink transmission using the corresponding one or more antenna combining weight configurations. In an example, the UE 115-b may receive multiple repetitions of a CSI-RS. For example, the UE 115-b may receive N+1 repetitions of the CSI-RS, where N is the number of antenna elements of a receive antenna panel at the UE 115-b. The UE 115-b may perform a 3D receive beam determination procedure to determine receive beam weights for each antenna element of the receive panel at the UE 115-b, then the UE 115-b may add the combined signals with the determined combining weights to determine a receive beamforming weight for the 3D receive beam. Additionally, or alternatively, the base station 105-b may transmit, and the UE 115-b may receive, PDSCH signaling with DMRS, PDCCH signaling with DMRS, or other signaling or reference signals for the UE 115-b to determine a receive beamforming weight for a 3D receive beam.

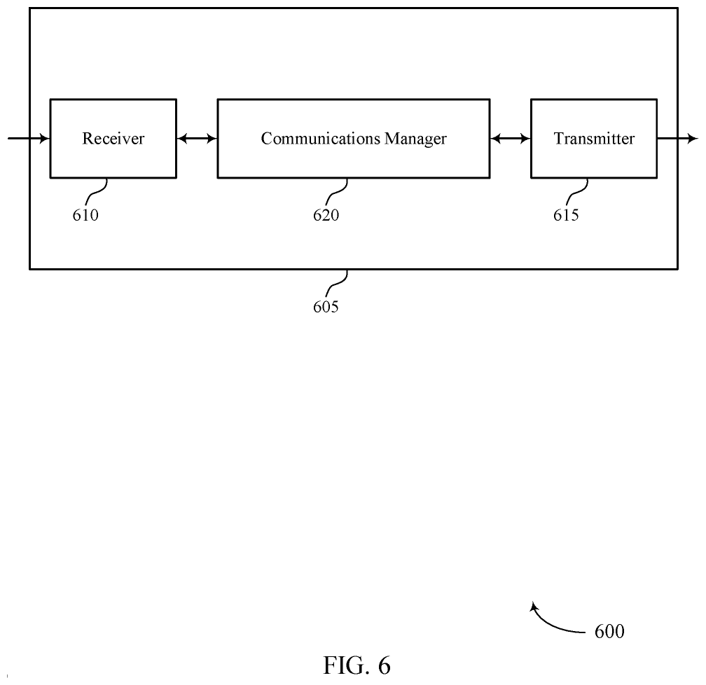

FIG. 6 shows a block diagram 600 of a device 605 that supports QCL information for 3D beamforming in holographic MIMO systems in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to QCL information for 3D beamforming in holographic MIMO systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to QCL information for 3D beamforming in holographic MIMO systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of QCL information for 3D beamforming in holographic MIMO systems as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory in electronic communication with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a base station, control signaling indicating a QCL configuration associated with MIMO communications within a distance threshold from the base station. The communications manager 620 may be configured as or otherwise support a means for receiving, from the base station, an indication of a downlink transmission associated with the QCL configuration within the distance threshold for MIMO communications from the base station. The communications manager 620 may be configured as or otherwise support a means for selecting a beam to receive the downlink transmission within the distance threshold for MIMO communications from the base station based on the QCL configuration.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for 3D beamforming in holographic MIMO systems, which may reduce latency and radio resource consumption in beam determination. As such, supported techniques may include improved network operations, and, in some examples, may promote network efficiencies, among other benefits.

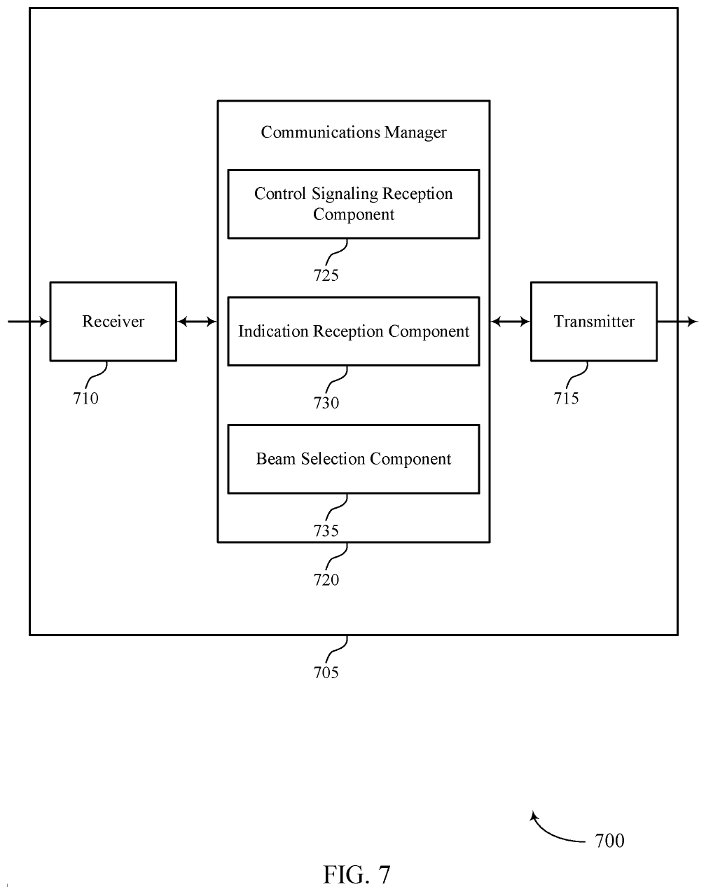

FIG. 7 shows a block diagram 700 of a device 705 that supports QCL information for 3D beamforming in holographic MIMO systems in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to QCL information for 3D beamforming in holographic MIMO systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to QCL information for 3D beamforming in holographic MIMO systems). In some examples, the transmitter 715 may be co-located with a receiver 710 in a transceiver module. The transmitter 715 may utilize a single antenna or a set of multiple antennas

The device 705, or various components thereof, may be an example of means for performing various aspects of QCL information for 3D beamforming in holographic MIMO systems as described herein. For example, the communications manager 720 may include a control signaling reception component 725, an indication reception component 730, a beam selection component 735, or any combination thereof. The communications manager 720) may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control signaling reception component 725 may be configured as or otherwise support a means for receiving, from a base station, control signaling indicating a QCL configuration associated with MIMO communications within a distance threshold from the base station. The indication reception component 730 may be configured as or otherwise support a means for receiving, from the base station, an indication of a downlink transmission associated with the QCL configuration within the distance threshold for MIMO communications from the base station. The beam selection component 735 may be configured as or otherwise support a means for selecting a beam to receive the downlink transmission within the distance threshold for MIMO communications from the base station based on the QCL configuration.

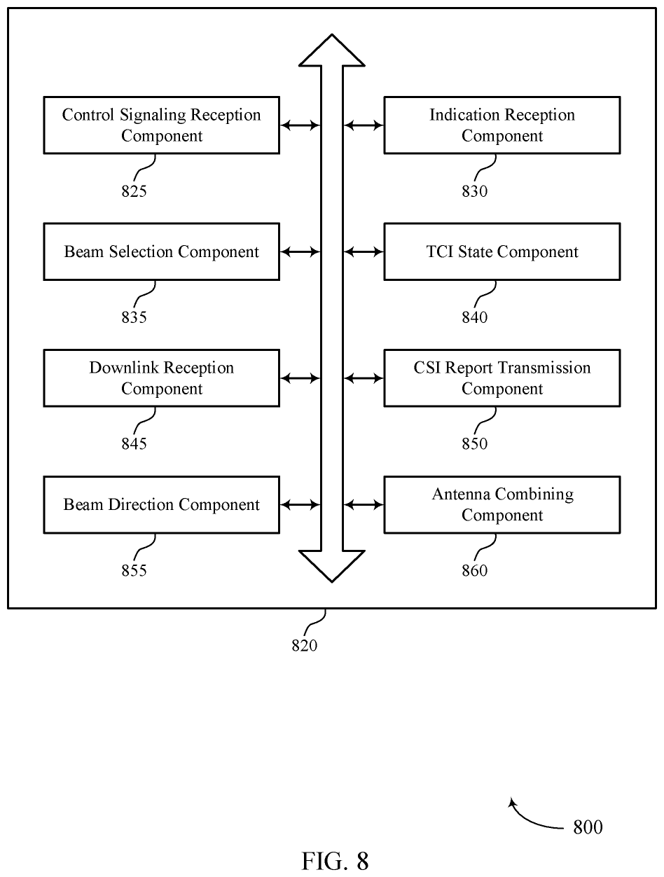

FIG. 8 shows a block diagram 800 of a communications manager 820) that supports QCL information for 3D beamforming in holographic MIMO systems in accordance with aspects of the present disclosure. The communications manager 820 may be an example of aspects of a communications manager 620, a communications manager 720, or both, as described herein. The communications manager 820, or various components thereof, may be an example of means for performing various aspects of QCL information for 3D beamforming in holographic MIMO systems as described herein. For example, the communications manager 820 may include a control signaling reception component 825, an indication reception component 830, a beam selection component 835, a TCI state component 840, a downlink reception component 845, a CSI report transmission component 850, a beam direction component 855, an antenna combining component 860, or any combination thereof. Each of these components may communicate, directly or indirectly, with one another (e.g., via one or more buses).

The communications manager 820 may support wireless communication at a UE in accordance with examples as disclosed herein. The control signaling reception component 825 may be configured as or otherwise support a means for receiving, from a base station, control signaling indicating a QCL configuration associated with MIMO communications within a distance threshold from the base station. The indication reception component 830 may be configured as or otherwise support a means for receiving, from the base station, an indication of a downlink transmission associated with the QCL configuration within the distance threshold for MIMO communications from the base station. The beam selection component 835 may be configured as or otherwise support a means for selecting a beam to receive the downlink transmission within the distance threshold for MIMO communications from the base station based on the QCL configuration.

In some examples, to support receiving the control signaling, the TCI state component 840 may be configured as or otherwise support a means for receiving the control signaling configuring a TCI state including the QCL configuration associated with the MIMO communications within the distance threshold from the base station.

In some examples, to support receiving the indication of the downlink transmission, the TCI state component 840 may be configured as or otherwise support a means for receiving an indication of the TCI state via an RRC message, a MAC-CE, or DCI.

In some examples, the control signaling includes a bit field indicating the TCI state is associated with the receive beam used for MIMO communications within the distance threshold from the base station.

In some examples, to support receiving the indication of the downlink transmission, the downlink reception component 845 may be configured as or otherwise support a means for receiving, from the base station, an indication of a set of multiple repetitions of the downlink transmission associated with the QCL configuration within the distance threshold for MIMO communications from the base station. In some examples, to support receiving the indication of the downlink transmission, the downlink reception component 845 may be configured as or otherwise support a means for receiving the set of multiple repetitions of the downlink transmission based on selecting the beam.

In some examples, to support receiving the set of multiple repetitions of the downlink transmission, the antenna combining component 860 may be configured as or otherwise support a means for receiving the set of multiple repetitions of the downlink transmission using a corresponding set of multiple antenna combining weight configurations. In some examples, to support receiving the set of multiple repetitions of the downlink transmission, the antenna combining component 860 may be configured as or otherwise support a means for determining a beam weight configuration for the beam to receive the downlink transmission based on receiving the set of multiple repetitions of the downlink transmission using the corresponding set of multiple antenna combining weight configurations.

In some examples, the downlink reception component 845 may be configured as or otherwise support a means for receiving, using the beam within the distance threshold from the base station, the downlink transmission including a periodic or semi-persistent CSI-RS. In some examples, the CSI report transmission component 850 may be configured as or otherwise support a means for transmitting, to the base station, a CSI report based on receiving the periodic or semi-persistent CSI-RS.

In some examples, the downlink reception component 845 may be configured as or otherwise support a means for receiving, using the beam within the distance threshold from the base station, the downlink transmission including an aperiodic CSI-RS. In some examples, the CSI report transmission component 850 may be configured as or otherwise support a means for transmitting, to the base station, a CSI report based on receiving the aperiodic CSI-RS.

In some examples, the downlink reception component 845 may be configured as or otherwise support a means for receiving, using the beam within the distance threshold from the base station, the downlink transmission including a PDSCH message.

In some examples, the downlink reception component 845 may be configured as or otherwise support a means for receiving, using the beam within the distance threshold from the base station, the downlink transmission including a PDCCH message.

In some examples, the beam direction component 855 may be configured as or otherwise support a means for receiving, from the base station, control signaling including an indication of a beam direction of a transmit beam from the base station. In some examples, the beam direction component 855 may be configured as or otherwise support a means for comparing the beam direction of the transmit beam to a position of the UE, where the beam is selected to receive the downlink transmission based on the position of the UE correlating to the beam direction of the transmit beam.

In some examples, the indication of the beam direction is an absolute positional value or a relative positional value associated with an antenna panel of the base station.

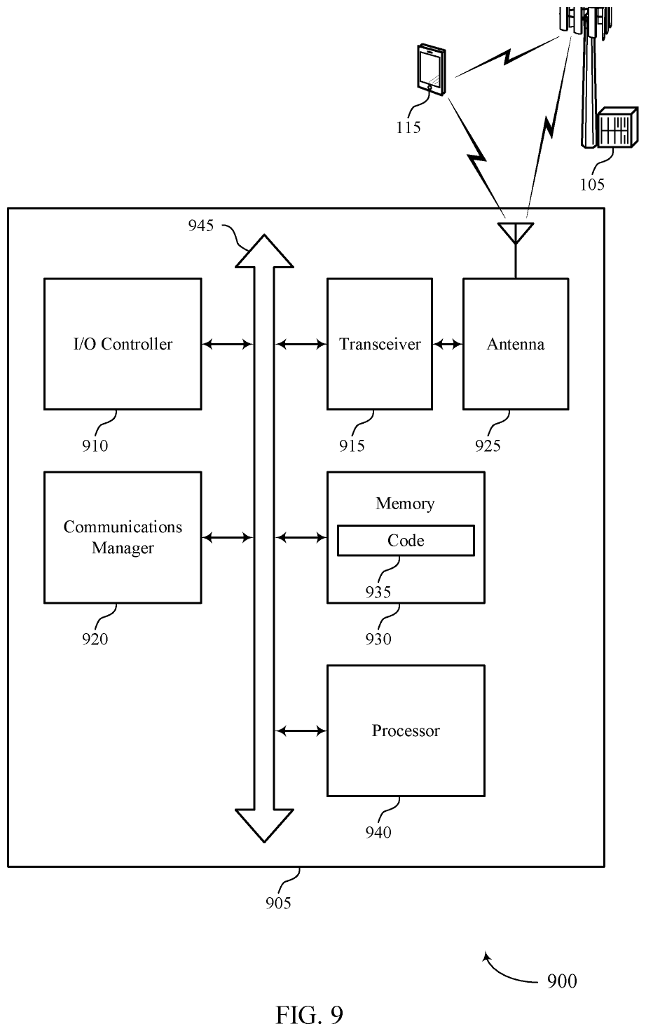

FIG. 9 shows a diagram of a system 900 including a device 905 that supports QCL information for 3D beamforming in holographic MIMO systems in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting QCL information for 3D beamforming in holographic MIMO systems). For example, the device 905 or a component of the device 905 may include a processor 940 and memory 930 in electronic communication with the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a base station, control signaling indicating a QCL configuration associated with MIMO communications within a distance threshold from the base station. The communications manager 920 may be configured as or otherwise support a means for receiving, from the base station, an indication of a downlink transmission associated with the QCL configuration within the distance threshold for MIMO communications from the base station. The communications manager 920 may be configured as or otherwise support a means for selecting a beam to receive the downlink transmission within the distance threshold for MIMO communications from the base station based on the QCL configuration.

By including or configuring the communications manager 920 in accordance with examples as described herein, the device 905 may support techniques for 3D beamforming in holographic MIMO systems, which may reduce latency and radio resource consumption in beam determination. As such, supported techniques may include improved network operations, and, in some examples, may promote network efficiencies, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of QCL information for 3D beamforming in holographic MIMO systems as described herein, or the processor 940 and the memory 930 may be otherwise configured to perform or support such operations.

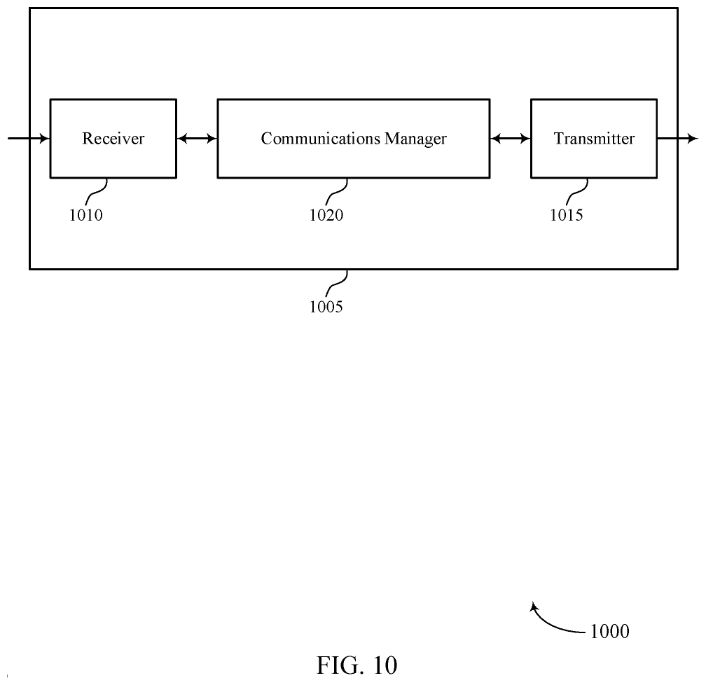

FIG. 10 shows a block diagram 1000 of a device 1005 that supports QCL information for 3D beamforming in holographic MIMO systems in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to QCL information for 3D beamforming in holographic MIMO systems). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to QCL information for 3D beamforming in holographic MIMO systems). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of QCL information for 3D beamforming in holographic MIMO systems as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory in electronic communication with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for transmitting, to a UE, control signaling indicating a QCL configuration associated with MIMO communications within a distance threshold from the base station. The communications manager 1020 may be configured as or otherwise support a means for transmitting, to the UE, an indication of a downlink transmission associated with the QCL configuration within the distance threshold for MIMO communications from the base station. The communications manager 1020 may be configured as or otherwise support a means for transmitting, to the UE, the downlink transmission using a beam within the distance threshold for MIMO communications from the base station.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for 3D beamforming in holographic MIMO systems, which may reduce latency and radio resource consumption in beam determination. As such, supported techniques may include improved network operations, and, in some examples, may promote network efficiencies, among other benefits.

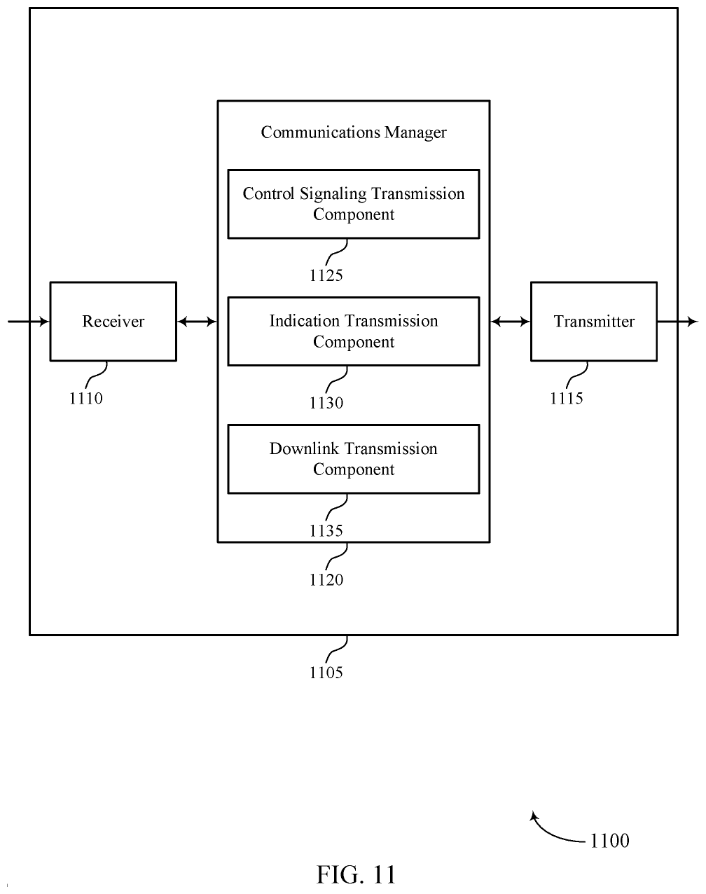

FIG. 11 shows a block diagram 1100 of a device 1105 that supports QCL information for 3D beamforming in holographic MIMO systems in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to QCL information for 3D beamforming in holographic MIMO systems). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to QCL information for 3D beamforming in holographic MIMO systems). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of QCL information for 3D beamforming in holographic MIMO systems as described herein. For example, the communications manager 1120 may include a control signaling transmission component 1125, an indication transmission component 1130, a downlink transmission component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The control signaling transmission component 1125 may be configured as or otherwise support a means for transmitting, to a UE, control signaling indicating a QCL configuration associated with MIMO communications within a distance threshold from the base station. The indication transmission component 1130 may be configured as or otherwise support a means for transmitting, to the UE, an indication of a downlink transmission associated with the QCL configuration within the distance threshold for MIMO communications from the base station. The downlink transmission component 1135 may be configured as or otherwise support a means for transmitting, to the UE, the downlink transmission using a beam within the distance threshold for MIMO communications from the base station.

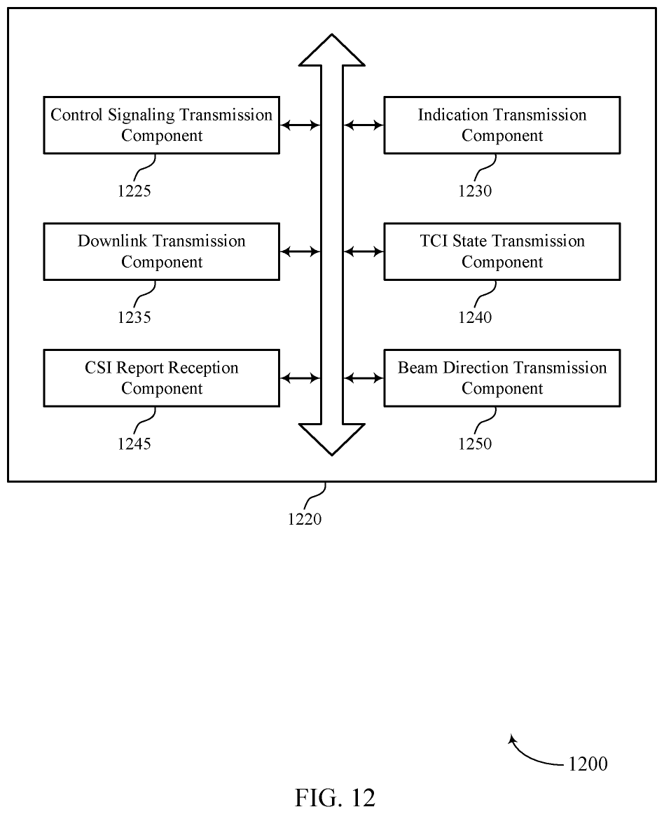

FIG. 12 shows a block diagram 1200 of a communications manager 1220 that supports QCL information for 3D beamforming in holographic MIMO systems in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of QCL information for 3D beamforming in holographic MIMO systems as described herein. For example, the communications manager 1220 may include a control signaling transmission component 1225, an indication transmission component 1230, a downlink transmission component 1235, a TCI state transmission component 1240, a CSI report reception component 1245, a beam direction transmission component 1250, or any combination thereof. Each of these components may communicate, directly or indirectly, with one another (e.g., via one or more buses).

The communications manager 1220 may support wireless communication at a base station in accordance with examples as disclosed herein. The control signaling transmission component 1225 may be configured as or otherwise support a means for transmitting, to a UE, control signaling indicating a QCL configuration associated with MIMO communications within a distance threshold from the base station. The indication transmission component 1230 may be configured as or otherwise support a means for transmitting, to the UE, an indication of a downlink transmission associated with the QCL configuration within the distance threshold for MIMO communications from the base station. The downlink transmission component 1235 may be configured as or otherwise support a means for transmitting, to the UE, the downlink transmission using a beam within the distance threshold for MIMO communications from the base station.

In some examples, to support transmitting the control signaling, the TCI state transmission component 1240 may be configured as or otherwise support a means for transmitting the control signaling indicating a TCI state including the QCL configuration associated with the MIMO communications within the distance threshold from the base station.

In some examples, to support transmitting the indication of the downlink transmission, the TCI state transmission component 1240 may be configured as or otherwise support a means for transmitting an indication of the TCI state via an RRC message, a MAC-CE, or DCI.

In some examples, the control signaling includes a bit field indicating the TCI state is associated with the receive beam used for MIMO communications within the distance threshold from the base station.

In some examples, to support transmitting the indication of the downlink transmission, the downlink transmission component 1235 may be configured as or otherwise support a means for transmitting, to the UE, an indication of a set of multiple repetitions of the downlink transmission associated with the QCL configuration within the distance threshold for MIMO communications from the base station. In some examples, to support transmitting the indication of the downlink transmission, the downlink transmission component 1235 may be configured as or otherwise support a means for transmitting the set of multiple repetitions of the downlink transmission.

In some examples, the downlink transmission component 1235 may be configured as or otherwise support a means for transmitting, using the beam within the distance threshold from the base station, the downlink transmission including a periodic or semi-persistent CSI-RS. In some examples, the CSI report reception component 1245 may be configured as or otherwise support a means for receiving, from the UE, a CSI report based on transmitting the periodic or semi-persistent CSI-RS.

In some examples, the downlink transmission component 1235 may be configured as or otherwise support a means for transmitting, using the beam within the distance threshold from the base station, the downlink transmission including an aperiodic CSI-RS. In some examples, the CSI report reception component 1245 may be configured as or otherwise support a means for receiving, from the UE, a CSI report based on transmitting the aperiodic CSI-RS.

In some examples, to support transmitting the downlink transmission, the downlink transmission component 1235 may be configured as or otherwise support a means for transmitting, using the beam within the distance threshold from the base station, the downlink transmission including a PDSCH message.

In some examples, to support transmitting the downlink transmission, the downlink transmission component 1235 may be configured as or otherwise support a means for transmitting, using the beam within the distance threshold from the base station, the downlink transmission including a PDCCH message.

In some examples, the beam direction transmission component 1250 may be configured as or otherwise support a means for transmitting, to the UE, control signaling including an indication of a beam direction of a transmit beam from the base station.

In some examples, the indication of the beam direction is an absolute positional value or a relative positional value associated with an antenna panel of the base station.

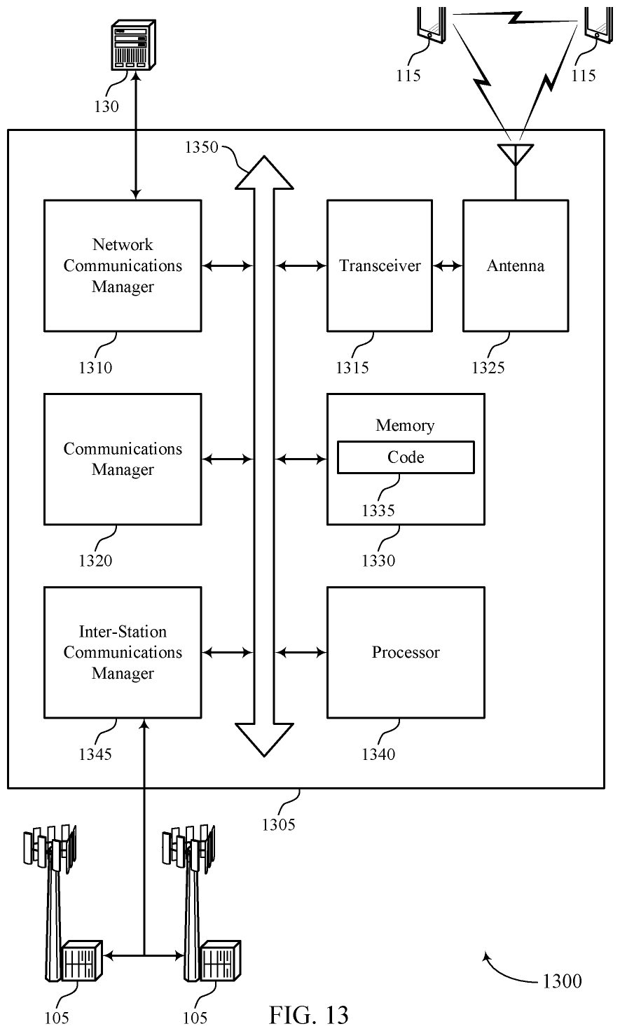

FIG. 13 shows a diagram of a system 1300 including a device 1305 that supports QCL information for 3D beamforming in holographic MIMO systems in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting QCL information for 3D beamforming in holographic MIMO systems). For example, the device 1305 or a component of the device 1305 may include a processor 1340 and memory 1330 in electronic communication with the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for transmitting, to a UE, control signaling indicating a QCL configuration associated with MIMO communications within a distance threshold from the base station. The communications manager 1320 may be configured as or otherwise support a means for transmitting, to the UE, an indication of a downlink transmission associated with the QCL configuration within the distance threshold for MIMO communications from the base station. The communications manager 1320 may be configured as or otherwise support a means for transmitting, to the UE, the downlink transmission using a beam within the distance threshold for MIMO communications from the base station.

By including or configuring the communications manager 1320 in accordance with examples as described herein, the device 1305 may support techniques for 3D beamforming in holographic MIMO systems, which may reduce latency and radio resource consumption in beam determination. As such, supported techniques may include improved network operations, and, in some examples, may promote network efficiencies, among other benefits.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of QCL information for 3D beamforming in holographic MIMO systems as described herein, or the processor 1340 and the memory 1330 may be otherwise configured to perform or support such operations.

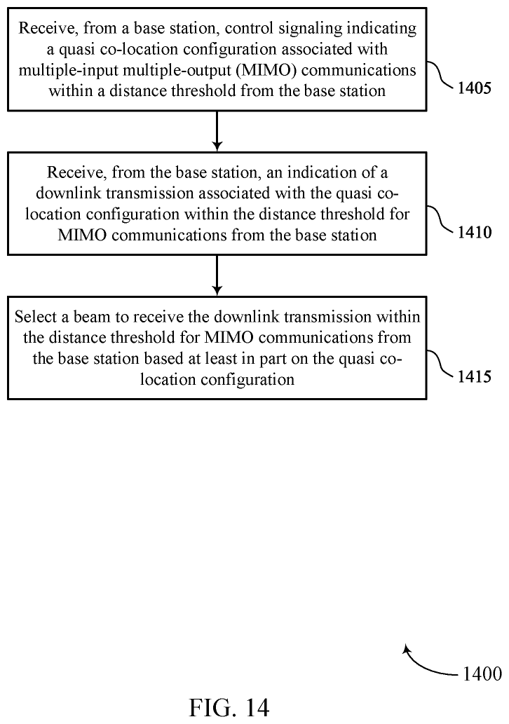

FIG. 14 shows a flowchart illustrating a method 1400 that supports QCL information for 3D beamforming in holographic MIMO systems in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a QCL configuration associated with MIMO communications within a distance threshold from the base station. The operations of 1405 may be performed in accordance with examples as disclosed herein. In some examples, aspects of the operations of 1405 may be performed by a control signaling reception component 825 as described with reference to FIG. 8.

At 1410, the method may include receiving, from the base station, an indication of a downlink transmission associated with the QCL configuration within the distance threshold for MIMO communications from the base station. The operations of 1410 may be performed in accordance with examples as disclosed herein. In some examples, aspects of the operations of 1410 may be performed by an indication reception component 830 as described with reference to FIG. 8.

At 1415, the method may include selecting a beam to receive the downlink transmission within the distance threshold for MIMO communications from the base station based on the QCL configuration. The operations of 1415 may be performed in accordance with examples as disclosed herein. In some examples, aspects of the operations of 1415 may be performed by a beam selection component 835 as described with reference to FIG. 8.

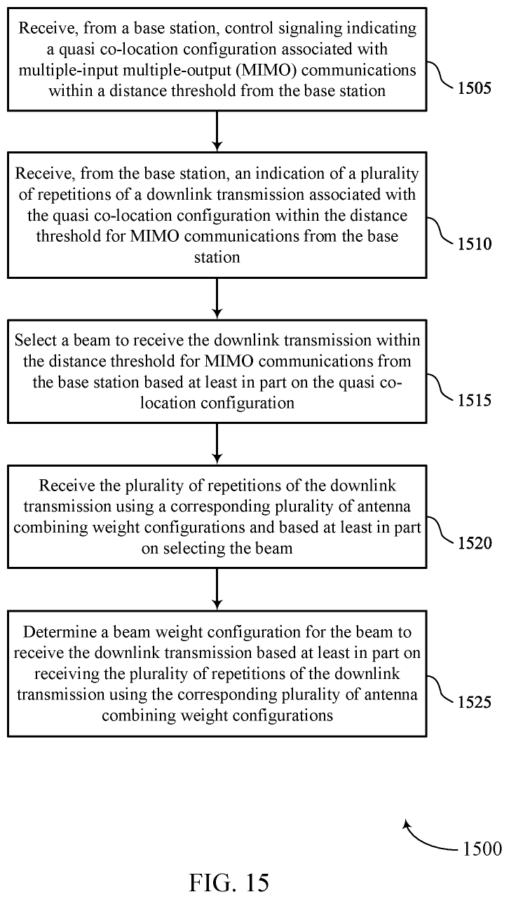

FIG. 15 shows a flowchart illustrating a method 1500 that supports QCL information for 3D beamforming in holographic MIMO systems in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling indicating a QCL configuration associated with MIMO communications within a distance threshold from the base station. The operations of 1505 may be performed in accordance with examples as disclosed herein. In some examples, aspects of the operations of 1505 may be performed by a control signaling reception component 825 as described with reference to FIG. 8.

At 1510, the method may include receiving, from the base station, an indication of a set of multiple repetitions of a downlink transmission associated with the QCL configuration within the distance threshold for MIMO communications from the base station. The operations of 1510 may be performed in accordance with examples as disclosed herein. In some examples, aspects of the operations of 1510 may be performed by a downlink reception component 845 as described with reference to FIG. 8.

At 1515, the method may include selecting a beam to receive the downlink transmission within the distance threshold for MIMO communications from the base station based on the QCL configuration. The operations of 1515 may be performed in accordance with examples as disclosed herein. In some examples, aspects of the operations of 1515 may be performed by a beam selection component 835 as described with reference to FIG. 8.

At 1520, the method may include receiving the set of multiple repetitions of the downlink transmission using a corresponding multiple antenna combining weight configurations and based on selecting the beam. The operations of 1520 may be performed in accordance with examples as disclosed herein. In some examples, aspects of the operations of 1520 may be performed by a downlink reception component 845 as described with reference to FIG. 8.

At 1525, the method may include determining a beam weight configuration for the beam to receive the downlink transmission based on receiving the set of multiple repetitions of the downlink transmission using the corresponding set of multiple antenna combining weight configurations. The operations of 1525 may be performed in accordance with examples as disclosed herein. In some examples, aspects of the operations of 1525 may be performed by an antenna combining component 860 as described with reference to FIG. 8.

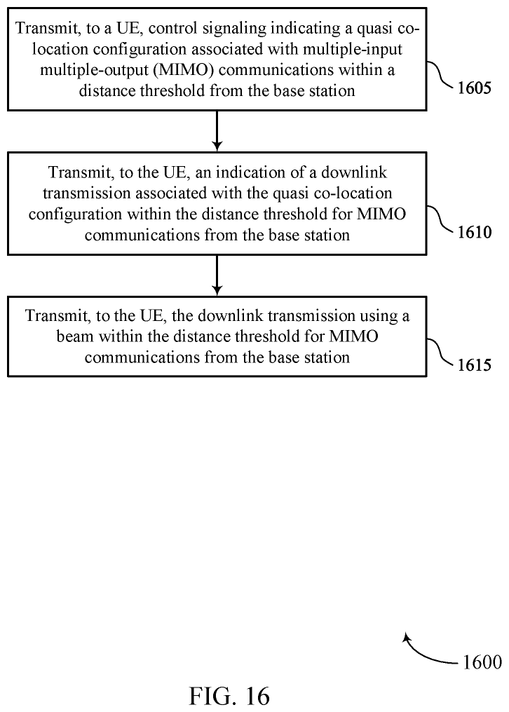

FIG. 16 shows a flowchart illustrating a method 1600 that supports QCL information for 3D beamforming in holographic MIMO systems in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, control signaling indicating a QCL configuration associated with MIMO communications within a distance threshold from the base station. The operations of 1605 may be performed in accordance with examples as disclosed herein. In some examples, aspects of the operations of 1605 may be performed by a control signaling transmission component 1225 as described with reference to FIG. 12.

At 1610, the method may include transmitting, to the UE, an indication of a downlink transmission associated with the QCL configuration within the distance threshold for MIMO communications from the base station. The operations of 1610 may be performed in accordance with examples as disclosed herein. In some examples, aspects of the operations of 1610 may be performed by an indication transmission component 1230 as described with reference to FIG. 12.

At 1615, the method may include transmitting, to the UE, the downlink transmission using a beam within the distance threshold for MIMO communications from the base station. The operations of 1615 may be performed in accordance with examples as disclosed herein. In some examples, aspects of the operations of 1615 may be performed by a downlink transmission component 1235 as described with reference to FIG. 12.

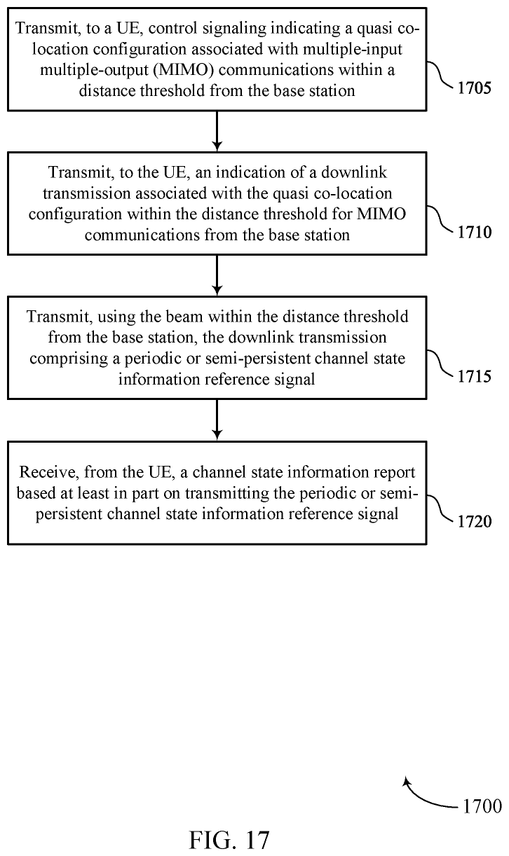

FIG. 17 shows a flowchart illustrating a method 1700 that supports QCL information for 3D beamforming in holographic MIMO systems in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, control signaling indicating a QCL configuration associated with MIMO communications within a distance threshold from the base station. The operations of 1705 may be performed in accordance with examples as disclosed herein. In some examples, aspects of the operations of 1705 may be performed by a control signaling transmission component 1225 as described with reference to FIG. 12.

At 1710, the method may include transmitting, to the UE, an indication of a downlink transmission associated with the QCL configuration within the distance threshold for MIMO communications from the base station. The operations of 1710 may be performed in accordance with examples as disclosed herein. In some examples, aspects of the operations of 1710 may be performed by an indication transmission component 1230 as described with reference to FIG. 12.

At 1715, the method may include transmitting, using the beam within the distance threshold from the base station, the downlink transmission including a periodic or semi-persistent CSI-RS. The operations of 1715 may be performed in accordance with examples as disclosed herein. In some examples, aspects of the operations of 1715 may be performed by a downlink transmission component 1235 as described with reference to FIG. 12.

At 1720, the method may include receiving, from the UE, a CSI report based on transmitting the periodic or semi-persistent CSI-RS. The operations of 1720 may be performed in accordance with examples as disclosed herein. In some examples, aspects of the operations of 1720 may be performed by a CSI report reception component 1245 as described with reference to FIG. 12.

The following provides an overview of aspects of the present disclosure:

Aspect 1: A method for wireless communication at a UE, comprising: receiving, from a base station, control signaling indicating a QCL configuration associated with MIMO communications within a distance threshold from the base station: receiving, from the base station, an indication of a downlink transmission associated with the QCL configuration within the distance threshold for MIMO communications from the base station: selecting a beam to receive the downlink transmission within the distance threshold for MIMO communications from the base station based at least in part on the QCL configuration.

Aspect 2: The method of aspect 1, wherein receiving the control signaling comprises: receiving the control signaling configuring a TCI state comprising the QCL configuration associated with the MIMO communications within the distance threshold from the base station.

Aspect 3: The method of aspect 2, wherein receiving the indication of the downlink transmission further comprises: receiving an indication of the TCI state via an RRC message, a MAC-CE, or DCI.

Aspect 4: The method of any of aspects 2 through 3, wherein the control signaling includes a bit field indicating the TCI state is associated with the receive beam used for MIMO communications within the distance threshold from the base station.

Aspect 5: The method of any of aspects 1 through 4, wherein receiving the indication of the downlink transmission comprises: receiving, from the base station, an indication of a plurality of repetitions of the downlink transmission associated with the QCL configuration within the distance threshold for MIMO communications from the base station: and receiving the plurality of repetitions of the downlink transmission based at least in part on selecting the beam.

Aspect 6: The method of aspect 5, wherein receiving the plurality of repetitions of the downlink transmission comprises: receiving the plurality of repetitions of the downlink transmission using a corresponding plurality of antenna combining weight configurations: and determining a beam weight configuration for the beam to receive the downlink transmission based at least in part on receiving the plurality of repetitions of the downlink transmission using the corresponding plurality of antenna combining weight configurations.

Aspect 7: The method of any of aspects 1 through 6, further comprising: receiving, using the beam within the distance threshold from the base station, the downlink transmission comprising a periodic or semi-persistent CSI-RS: and transmitting, to the base station, a CSI report based at least in part on receiving the periodic or semi-persistent CSI-RS.

Aspect 8: The method of any of aspects 1 through 7, further comprising: receiving, using the beam within the distance threshold from the base station, the downlink transmission comprising an aperiodic CSI-RS: and transmitting, to the base station, a CSI report based at least in part on receiving the aperiodic CSI-RS.

Aspect 9: The method of any of aspects 1 through 8, further comprising: receiving, using the beam within the distance threshold from the base station, the downlink transmission comprising a PDSCH message.

Aspect 10: The method of any of aspects 1 through 9, further comprising: receiving, using the beam within the distance threshold from the base station, the downlink transmission comprising a PDCCH message.

Aspect 11: The method of any of aspects 1 through 10, further comprising: receiving, from the base station, control signaling comprising an indication of a beam direction of a transmit beam from the base station: comparing the beam direction of the transmit beam to a position of the UE, wherein the beam is selected to receive the downlink transmission based at least in part on the position of the UE correlating to the beam direction of the transmit beam.

Aspect 12: The method of aspect 11, wherein the indication of the beam direction is an absolute positional value or a relative positional value associated with an antenna panel of the base station.

Aspect 13: A method for wireless communication at a base station, comprising: transmitting, to a UE, control signaling indicating a QCL configuration associated with MIMO communications within a distance threshold from the base station: transmitting, to the UE, an indication of a downlink transmission associated with the QCL configuration within the distance threshold for MIMO communications from the base station: transmitting, to the UE, the downlink transmission using a beam within the distance threshold for MIMO communications from the base station.

Aspect 14: The method of aspect 13, wherein transmitting the control signaling comprises: transmitting the control signaling indicating a TCI state comprising the QCL configuration associated with the MIMO communications within the distance threshold from the base station.

Aspect 15: The method of aspect 14, wherein transmitting the indication of the downlink transmission further comprises: transmitting an indication of the TCI state via an RRC message, a MAC-CE, or DCI.

Aspect 16: The method of any of aspects 14 through 15, wherein the control signaling includes a bit field indicating the TCI state is associated with the receive beam used for MIMO communications within the distance threshold from the base station.

Aspect 17: The method of any of aspects 13 through 16, wherein transmitting the indication of the downlink transmission comprises: transmitting, to the UE, an indication of a plurality of repetitions of the downlink transmission associated with the QCL configuration within the distance threshold for MIMO communications from the base station: and transmitting the plurality of repetitions of the downlink transmission.

Aspect 18: The method of any of aspects 13 through 17, further comprising: transmitting, using the beam within the distance threshold from the base station, the downlink transmission comprising a periodic or semi-persistent CSI-RS: and receiving, from the UE, a CSI report based at least in part on transmitting the periodic or semi-persistent CSI-RS.

Aspect 19: The method of any of aspects 13 through 18, further comprising: transmitting, using the beam within the distance threshold from the base station, the downlink transmission comprising an aperiodic CSI-RS: and receiving, from the UE, a CSI report based at least in part on transmitting the aperiodic CSI-RS.

Aspect 20: The method of any of aspects 13 through 19, wherein transmitting the downlink transmission comprises: transmitting, using the beam within the distance threshold from the base station, the downlink transmission comprising a PDSCH message.

Aspect 21: The method of any of aspects 13 through 20, wherein transmitting the downlink transmission comprises: transmitting, using the beam within the distance threshold from the base station, the downlink transmission comprising a PDCCH message.

Aspect 22: The method of any of aspects 13 through 21, further comprising: transmitting, to the UE, control signaling comprising an indication of a beam direction of a transmit beam from the base station.

Aspect 23: The method of aspect 22, wherein the indication of the beam direction is an absolute positional value or a relative positional value associated with an antenna panel of the base station.

Aspect 24: An apparatus for wireless communication at a UE, comprising a processor: memory in electronic communication with the processor, and instructions stored in the memory, where the instructions are executable by the processor to perform a method of any of aspects 1 through 12.

Aspect 25: An apparatus for wireless communication at a UE, comprising at least one means for performing a method of any of aspects 1 through 12.

Aspect 26: A non-transitory computer-readable medium storing code for wireless communication at a UE, the code comprising instructions executable by a processor to perform a method of any of aspects 1 through 12.

Aspect 27: An apparatus for wireless communication at a base station, comprising a processor: memory in electronic communication with the processor, and instructions stored in the memory, where the instructions are executable by the processor to perform a method of any of aspects 13 through 23.

Aspect 28: An apparatus for wireless communication at a base station, comprising at least one means for performing a method of any of aspects 13 through 23.

Aspect 29: A non-transitory computer-readable medium storing code for wireless communication at a base station, the code comprising instructions executable by a processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling indicating a quasi co-location configuration associated with multiple-input multiple-output (MIMO) communications within a distance threshold from the base station;
receiving, from the base station, an indication of a downlink transmission associated with the quasi co-location configuration within the distance threshold for MIMO communications from the base station;
selecting a beam to receive the downlink transmission within the distance threshold for MIMO communications from the base station based at least in part on the quasi co-location configuration.

2. The method of claim 1, wherein receiving the control signaling comprises:
receiving the control signaling configuring a transmission configuration indicator state comprising the quasi co-location configuration associated with the MIMO communications within the distance threshold from the base station.

3. The method of claim 2, wherein receiving the indication of the downlink transmission further comprises:
receiving an indication of the transmission configuration indicator state via a radio resource control message, a medium access control control element, or downlink control information.

4. The method of claim 2, wherein the control signaling includes a bit field indicating the transmission configuration indicator state is associated with the receive beam used for MIMO communications within the distance threshold from the base station.

5. The method of claim 1, wherein receiving the indication of the downlink transmission comprises:
receiving, from the base station, an indication of a plurality of repetitions of the downlink transmission associated with the quasi co-location configuration within the distance threshold for MIMO communications from the base station; and
receiving the plurality of repetitions of the downlink transmission based at least in part on selecting the beam.

6. The method of claim 5, wherein receiving the plurality of repetitions of the downlink transmission comprises:
receiving the plurality of repetitions of the downlink transmission using a corresponding plurality of antenna combining weight configurations; and
determining a beam weight configuration for the beam to receive the downlink transmission based at least in part on receiving the plurality of repetitions of the downlink transmission using the corresponding plurality of antenna combining weight configurations.

7. The method of claim 1, further comprising:
receiving, using the beam within the distance threshold from the base station, the downlink transmission comprising a periodic or semi-persistent channel state information reference signal; and
transmitting, to the base station, a channel state information report based at least in part on receiving the periodic or semi-persistent channel state information reference signal.

8. The method of claim 1, further comprising:
receiving, using the beam within the distance threshold from the base station, the downlink transmission comprising an aperiodic channel state information reference signal; and
transmitting, to the base station, a channel state information report based at least in part on receiving the aperiodic channel state information reference signal.

9. The method of claim 1, further comprising:
receiving, using the beam within the distance threshold from the base station, the downlink transmission comprising a physical downlink shared channel message.

10. The method of claim 1, further comprising:
receiving, using the beam within the distance threshold from the base station, the downlink transmission comprising a physical downlink control channel message.

11. The method of claim 1, further comprising:
receiving, from the base station, control signaling comprising an indication of a beam direction of a transmit beam from the base station;
comparing the beam direction of the transmit beam to a position of the UE, wherein the beam is selected to receive the downlink transmission based at least in part on the position of the UE correlating to the beam direction of the transmit beam.

12. The method of claim 11, wherein the indication of the beam direction is an absolute positional value or a relative positional value associated with an antenna panel of the base station.

13. A method for wireless communication at a base station, comprising:
transmitting, to a user equipment (UE), control signaling indicating a quasi co-location configuration associated with multiple-input multiple-output (MIMO) communications within a distance threshold from the base station;
transmitting, to the UE, an indication of a downlink transmission associated with the quasi co-location configuration within the distance threshold for MIMO communications from the base station;
transmitting, to the UE, the downlink transmission using a beam within the distance threshold for MIMO communications from the base station.

14. The method of claim 13, wherein transmitting the control signaling comprises:
transmitting the control signaling indicating a transmission configuration indicator state comprising the quasi co-location configuration associated with the MIMO communications within the distance threshold from the base station.

15. The method of claim 14, wherein transmitting the indication of the downlink transmission further comprises:
transmitting an indication of the transmission configuration indicator state via a radio resource control message, a medium access control control element, or downlink control information.

16. The method of claim 14, wherein the control signaling includes a bit field indicating the transmission configuration indicator state is associated with the receive beam used for MIMO communications within the distance threshold from the base station.

17. The method of claim 13, wherein transmitting the indication of the downlink transmission comprises:
transmitting, to the UE, an indication of a plurality of repetitions of the downlink transmission associated with the quasi co-location configuration within the distance threshold for MIMO communications from the base station; and
transmitting the plurality of repetitions of the downlink transmission.

18. The method of claim 13, further comprising:
transmitting, using the beam within the distance threshold from the base station, the downlink transmission comprising a periodic or semi-persistent channel state information reference signal; and
receiving, from the UE, a channel state information report based at least in part on transmitting the periodic or semi-persistent channel state information reference signal.

19. The method of claim 13, further comprising:
transmitting, using the beam within the distance threshold from the base station, the downlink transmission comprising an aperiodic channel state information reference signal; and
receiving, from the UE, a channel state information report based at least in part on transmitting the aperiodic channel state information reference signal.

20. The method of claim 13, wherein transmitting the downlink transmission comprises:
transmitting, using the beam within the distance threshold from the base station, the downlink transmission comprising a physical downlink shared channel message.

21. The method of claim 13, wherein transmitting the downlink transmission comprises:
transmitting, using the beam within the distance threshold from the base station, the downlink transmission comprising a physical downlink control channel message.

22. The method of claim 13, further comprising:
transmitting, to the UE, control signaling comprising an indication of a beam direction of a transmit beam from the base station.

23. The method of claim 22, wherein the indication of the beam direction is an absolute positional value or a relative positional value associated with an antenna panel of the base station.

24. An apparatus for wireless communication at a user equipment (UE), comprising:
a processor;
memory in electronic communication with the processor; and
instructions stored in the memory, wherein the instructions are executable by the processor to:
receive, from a base station, control signaling indicating a quasi co-location configuration associated with multiple-input multiple-output (MIMO) communications within a distance threshold from the base station;
receive, from the base station, an indication of a downlink transmission associated with the quasi co-location configuration within the distance threshold for MIMO communications from the base station;
select a beam to receive the downlink transmission within the distance threshold for MIMO communications from the base station based at least in part on the quasi co-location configuration.

25. The apparatus of claim 24, wherein the instructions executable by the processor to receive the control signaling comprise instructions executable by the processor to:
receive the control signaling configuring a transmission configuration indicator state comprising the quasi co-location configuration associated with the MIMO communications within the distance threshold from the base station.

26. The apparatus of claim 25, wherein the instructions executable by the processor to receive the indication of the downlink transmission comprise instructions executable by the processor to:
receive an indication of the transmission configuration indicator state via a radio resource control message, a medium access control control element, or downlink control information.

27. The apparatus of claim 25, wherein the control signaling includes a bit field indicating the transmission configuration indicator state is associated with the receive beam used for MIMO communications within the distance threshold from the base station.

28. An apparatus for wireless communication at a base station, comprising:
a processor;
memory in electronic communication with the processor; and
instructions stored in the memory, wherein the instructions are executable by the processor to:
transmit, to a user equipment (UE), control signaling indicating a quasi co-location configuration associated with multiple-input multiple-output (MIMO) communications within a distance threshold from the base station;
transmit, to the UE, an indication of a downlink transmission associated with the quasi co-location configuration within the distance threshold for MIMO communications from the base station;
transmit, to the UE, the downlink transmission using a beam within the distance threshold for MIMO communications from the base station.

29. The apparatus of claim 28, wherein the instructions executable by the processor to transmit the control signaling comprise instructions executable by the processor to:
transmit the control signaling indicating a transmission configuration indicator state comprising the quasi co-location configuration associated with the MIMO communications within the distance threshold from the base station.

30. The apparatus of claim 29, wherein the instructions executable by the processor to transmit the indication of the downlink transmission comprise instructions executable by the processor to:
transmit an indication of the transmission configuration indicator state via a radio resource control message, a medium access control control element, or downlink control information.
